(19) United States
(12) Patent Application Publication
(10) Pub. No.: US 2023/0283325 A1
(43) Pub. Date: Sep. 7, 2023

(54) METHOD AND DEVICE IN NODES USED FOR WIRELESS COMMUNICATION

(71) Applicants: Lu WU, Shanghai (CN); Xiaobo ZHANG, Shanghai (CN)

(72) Inventors: Lu WU, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/197,109

(22) Filed: May 15, 2023

Related U.S. Application Data
(63) Continuation of application No. PCT/CN2021/129933, filed on Nov. 11, 2021.

(30) Foreign Application Priority Data
Nov. 16, 2020 (CN) 202011276215.8

(51) Int. Cl. H04B 7/0452; H04B 7/06

(52) U.S. Cl. CPC H04B 7/0452; H04B 7/06964

(57) ABSTRACT

The present application discloses a method and a device in a node for wireless communications. A first node receives a first signal set and a second signal set; a measurement of the first signal set being used to determine a first link failure; and a measurement of the second signal set being used to determine a second link failure; and as a response to the action of determining a first link failure, starts a first link recovery procedure; and determining according to at least one of a first parameter or a second parameter whether to trigger a second link recovery procedure as a response to the action of determining a second link failure. Each of the first signal set and the second signal set respectively comprises at least one reference signal associated with a first cell.

### CROSS REFERENCE TO RELATED APPLICATIONS

This application is the continuation of the international patent application No. PCT/CN2021/129933, filed on Nov. 11, 2021, which claims the priority benefit of Chinese Patent Application No. 202011276215.8, filed on Nov. 16, 2020, the full disclosure of which is incorporated herein by reference.

### BACKGROUND

### Technical Field

The present application relates to transmission methods and devices in wireless communication systems, and in particular to a method and device for radio signal transmission in a wireless communication system supporting cellular networks.

### Related Art

In 5G New Radio (NR), Massive Multi-Input Multi-Output (MIMO) is a key technology. In Massive MIMO, multiple antennas form through beamforming a narrow beam pointing in a specific direction to enhance communication quality. In 5G NR, the beam failure recovery mechanism has been adopted in response to quick recovery from beam failure, namely, a User Equipment (UE) performs measurements of serving beams in communications, and will start the beam failure recovery mechanism immediately after finding that the quality of serving beams is bad, and then a base station will change its serving beams.

In multi-Transmission and Reception Point (multi-TRP) cases, when there occurs a beam failure in beam-based communications, how to resume a beam quickly shall be paid further consideration.

### SUMMARY

Inventors find through researches that a mechanism for beam failure recovery in a multi-TRP case is a key issue that needs to be studied.

To address the above problem, the present application provides a solution. It should be noted that though the present application only took the massive MIMO and beam-based communications as a typical or exemplary scenario in the statement above, it is also applicable to other scenarios such as LTE multi-antenna system, where similar technical effects can be achieved. Additionally, the adoption of a unified solution for various scenarios, including but not limited to massive MIMO, beam-based communications, and LTE multi-antenna system, contributes to the reduction of hardcore complexity and costs. In the case of no conflict, the embodiments of any node and the characteristics in the embodiments may be applied to any other node, and vice versa. What's more, the embodiments in the present application and the characteristics in the embodiments can be arbitrarily combined if there is no conflict.

In one embodiment, interpretations of the terminology in the present application refer to definitions given in the 3GPP TS36 series.

In one embodiment, interpretations of the terminology in the present application refer to definitions given in the 3GPP TS38 series.

In one embodiment, interpretations of the terminology in the present application refer to definitions given in the 3GPP TS37 series.

In one embodiment, interpretations of the terminology in the present application refer to definitions given in Institute of Electrical and Electronics Engineers (IEEE) protocol specifications.

The present application provides a method in a first node for wireless communications, comprising:
receiving a first signal set and a second signal set; a measurement of the first signal set being used to determine a first link failure; and a measurement of the second signal set being used to determine a second link failure; and
as a response to the action of determining a first link failure, starting a first link recovery procedure; and
determining according to a first parameter whether to trigger a second link recovery procedure as a response to the action of determining a second link failure;
herein, each of the first signal set and the second signal set respectively comprises at least one reference signal associated with a first cell, and there exists at least one reference signal that only belongs to one of the first signal set or the second signal set; the first parameter is a time of the first link recovery procedure relative to the action of determining a second link failure.

The present application provides a method in a first node for wireless communications, comprising:
receiving a first signal set and a second signal set; a measurement of the first signal set being used to determine a first link failure; and a measurement of the second signal set being used to determine a second link failure; and
as a response to the action of determining a first link failure, starting a first link recovery procedure; and
determining according to a second parameter whether to trigger a second link recovery procedure as a response to the action of determining a second link failure;
herein, each of the first signal set and the second signal set respectively comprises at least one reference signal associated with a first cell, and there exists at least one reference signal that only belongs to one of the first signal set or the second signal set; the second parameter is whether the second link recovery procedure comprises a random access procedure.

The present application provides a method in a first node for wireless communications, comprising:
receiving a first signal set and a second signal set; a measurement of the first signal set being used to determine a first link failure; and a measurement of the second signal set being used to determine a second link failure; and
as a response to the action of determining a first link failure, starting a first link recovery procedure; and determining according to a first parameter and a second parameter whether to trigger a second link recovery procedure as a response to the action of determining a second link failure;
herein, each of the first signal set and the second signal set respectively comprises at least one reference signal associated with a first cell, and there exists at least one reference signal that only belongs to one of the first signal set or the second signal set; the first parameter is a time of the first link recovery procedure relative to the action of determining a second link failure, and the second parameter is whether the second link recovery procedure comprises a random access procedure.

In one embodiment, a problem to be solved in the present application is: for multi-TRP, when a beam failure occurs, how to resume a beam as fast as possible is a key issue to be studied.

In one embodiment, the essence of the above method lies in that a first signal set and a second signal set respectively determine a first link failure and a second link failure for a first cell, where whether a second link recovery procedure is triggered is related to at least one of a time of a first link recovery procedure relative to the action of determining a second link failure or whether a second link recovery procedure comprises a random access procedure. An advantage of using the above method lies in that for a same cell, the monitoring of two link failures reduces the chance of the occurrence of communication interruption in the cell, thus enhancing the user's communication quality.

According to one aspect of the present application, characterized in that the phrase that a measurement of the first signal set is used to determine a first link failure comprises: as a response to a received quality of each reference signal in the first signal set being lower than a first threshold, reporting to higher layers a first-type indication used for updating a first counter; the phrase of a measurement of the second signal set being used to determine a second link failure comprises: as a response to a received quality of each reference signal in the second signal set being lower than a second threshold, reporting to higher layers a second-type indication used for updating a second counter.

According to one aspect of the present application, characterized in that when a first condition is satisfied, the first transceiver drops triggering the second link recovery procedure; where the first condition comprises that the first link recovery procedure is started before the action of determining a second link failure.

According to one aspect of the present application, characterized in that when a second condition is satisfied, as a response to the action of determining a second link failure, the first transceiver triggers the second link recovery procedure; where the second condition comprises that the first link recovery procedure is successfully completed before the action of determining a second link failure.

According to one aspect of the present application, characterized in that when a third condition is satisfied, the first transceiver starts the second link recovery procedure; where the third condition comprises that the first link recovery procedure is started after the action of determining a second link failure.

According to one aspect of the present application, characterized in that when the third condition and a fourth condition are both satisfied, as a response to triggering a first link recovery procedure, the first transceiver cancels the second link recovery procedure; where the fourth condition comprises that the second link recovery procedure is started and not successfully completed before the action of determining a first link failure.

According to one aspect of the present application, characterized in that when a fifth condition is satisfied, as a response to the action of determining a second link failure, the first transceiver triggers the second link recovery procedure; when the fifth condition is unsatisfied, the first transceiver drops triggering a second link recovery procedure; where the fifth condition comprises that the second link recovery procedure comprises a random access procedure.

The present application provides a method in a second node for wireless communications, comprising:
a second transmitter, transmitting a first signal set and a second signal set; and
a second transceiver, monitoring whether a first link recovery procedure is started;
herein, when a measurement of the first signal set is used to determine a first link failure, the first link recovery procedure is started; when a measurement of the second signal set is used to determine a second link failure, a first parameter is used to determine whether a second link recovery procedure is triggered; each of the first signal set and the second signal set respectively comprises at least one reference signal associated with a first cell, and there exists at least one reference signal that only belongs to one of the first signal set or the second signal set; the first parameter is a time of the first link recovery procedure relative to the action of determining a second link failure.

The present application provides a method in a second node for wireless communications, comprising:
a second transmitter, transmitting a first signal set and a second signal set; and
a second transceiver, monitoring whether a first link recovery procedure is started;
herein, when a measurement of the first signal set is used to determine a first link failure, the first link recovery procedure is started; when a measurement of the second signal set is used to determine a second link failure, a second parameter is used to determine whether a second link recovery procedure is triggered; each of the first signal set and the second signal set respectively comprises at least one reference signal associated with a first cell, and there exists at least one reference signal that only belongs to one of the first signal set or the second signal set; the second parameter is whether the second link recovery procedure comprises a random access procedure.

The present application provides a method in a second node for wireless communications, comprising:
a second transmitter, transmitting a first signal set and a second signal set; and
a second transceiver, monitoring whether a first link recovery procedure is started;
herein, when a measurement of the first signal set is used to determine a first link failure, the first link recovery procedure is started; when a measurement of the second signal set is used to determine a second link failure, a first parameter and a second parameter are used to determine whether a second link recovery procedure is triggered; each of the first signal set and the second signal set respectively comprises at least one reference signal associated with a first cell, and there exists at least one reference signal that only belongs to one of the first signal set or the second signal set; the first parameter is a time of the first link recovery procedure relative to the action of determining a second link failure, and the second parameter is whether the second link recovery procedure comprises a random access procedure.

According to one aspect of the present application, characterized in that the second transceiver monitors whether the second link recovery procedure is started.

According to one aspect of the present application, characterized in that when a first condition is satisfied, triggering of the second link recovery procedure is dropped; where the first condition comprises that the first link recovery procedure is started before the action of determining a second link failure.

According to one aspect of the present application, characterized in that when a second condition is satisfied, as a response to the action of determining a second link failure, the second link recovery procedure is triggered; where the second condition comprises that the first link recovery procedure is successfully completed before the action of determining a second link failure.

According to one aspect of the present application, characterized in that when a third condition is satisfied, the second link recovery procedure is triggered; where the third condition comprises that the first link recovery procedure is started after the action of determining a second link failure.

According to one aspect of the present application, characterized in that when the third condition and a fourth condition are both satisfied, as a response to the first link recovery procedure being triggered, the second link recovery procedure is canceled; where the fourth condition comprises that the second link recovery procedure is started and not successfully completed before the action of determining a first link failure.

According to one aspect of the present application, characterized in that when a fifth condition is satisfied, as a response to the action of determining a second link failure, the second link recovery procedure is triggered; when the fifth condition is unsatisfied, triggering of the second link recovery procedure is dropped; where the fifth condition comprises that the second link recovery procedure comprises a random access procedure.

The present application provides a first node for wireless communications, comprising:
a first receiver, receiving a first signal set and a second signal set; a measurement of the first signal set being used to determine a first link failure; and a measurement of the second signal set being used to determine a second link failure; and
a first transceiver, as a response to the action of determining a first link failure, starting a first link recovery procedure; and determining according to a first parameter whether to trigger a second link recovery procedure as a response to the action of determining a second link failure;
herein, each of the first signal set and the second signal set respectively comprises at least one reference signal associated with a first cell, and there exists at least one reference signal that only belongs to one of the first signal set or the second signal set; the first parameter is a time of the first link recovery procedure relative to the action of determining a second link failure.

The present application provides a first node for wireless communications, comprising:
a first receiver, receiving a first signal set and a second signal set; a measurement of the first signal set being used to determine a first link failure; and a measurement of the second signal set being used to determine a second link failure; and
a first transceiver, as a response to the action of determining a first link failure, starting a first link recovery procedure; and determining according to a second parameter whether to trigger a second link recovery procedure as a response to the action of determining a second link failure;
herein, each of the first signal set and the second signal set respectively comprises at least one reference signal associated with a first cell, and there exists at least one reference signal that only belongs to one of the first signal set or the second signal set; the second parameter is whether the second link recovery procedure comprises a random access procedure.

The present application provides a first node for wireless communications, comprising:
a first receiver, receiving a first signal set and a second signal set; a measurement of the first signal set being used to determine a first link failure; and a measurement of the second signal set being used to determine a second link failure; and
a first transceiver, as a response to the action of determining a first link failure, starting a first link recovery procedure; and determining according to a first parameter and a second parameter whether to trigger a second link recovery procedure as a response to the action of determining a second link failure;
herein, each of the first signal set and the second signal set respectively comprises at least one reference signal associated with a first cell, and there exists at least one reference signal that only belongs to one of the first signal set or the second signal set; the first parameter is a time of the first link recovery procedure relative to the action of determining a second link failure, and the second parameter is whether the second link recovery procedure comprises a random access procedure.

The present application provides a second node for wireless communications, comprising:
a second transmitter, transmitting a first signal set and a second signal set; and
a second transceiver, monitoring whether a first link recovery procedure is started;
herein, when a measurement of the first signal set is used to determine a first link failure, the first link recovery procedure is started; when a measurement of the second signal set is used to determine a second link failure, a first parameter is used to determine whether a second link recovery procedure is triggered; each of the first signal set and the second signal set respectively comprises at least one reference signal associated with a first cell, and there exists at least one reference signal that only belongs to one of the first signal set or the second signal set; the first parameter is a time of the first link recovery procedure relative to the action of determining a second link failure.

The present application provides a second node for wireless communications, comprising:
a second transmitter, transmitting a first signal set and a second signal set; and
a second transceiver, monitoring whether a first link recovery procedure is started;
herein, when a measurement of the first signal set is used to determine a first link failure, the first link recovery procedure is started; when a measurement of the second signal set is used to determine a second link failure, a second parameter is used to determine whether a second link recovery procedure is triggered; each of the first signal set and the second signal set respectively comprises at least one reference signal associated with a first cell, and there exists at least one reference signal that only belongs to one of the first signal set or the second signal set; the second parameter is whether the second link recovery procedure comprises a random access procedure.

The present application provides a second node for wireless communications, comprising:
a second transmitter, transmitting a first signal set and a second signal set; and
a second transceiver, monitoring whether a first link recovery procedure is started;
herein, when a measurement of the first signal set is used to determine a first link failure, the first link recovery procedure is started; when a measurement of the second signal set is used to determine a second link failure, a first parameter and a second parameter are used to determine whether a second link recovery procedure is triggered; each of the first signal set and the second signal set respectively comprises at least one reference signal associated with a first cell, and there exists at least one reference signal that only belongs to one of the first signal set or the second signal set; the first parameter is a time of the first link recovery procedure relative to the action of determining a second link failure, and the second parameter is whether the second link recovery procedure comprises a random access procedure.

In one embodiment, compared with the prior art, the present application is advantageous in the following aspects:
for a same cell, the monitoring of two link failures reduces the chance of occurrence of communication interruption in the cell, thus enhancing the user's communication quality.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of a first signal set, a second signal set, a first link failure and a second link failure according to one embodiment of the present application.

FIG. 2 illustrates a schematic diagram of a network architecture according to one embodiment of the present application.

FIG. 3 illustrates a schematic diagram of a radio protocol architecture of a user plane and a control plane according to one embodiment of the present application.

FIG. 4 illustrates a schematic diagram of a first communication device and a second communication device according to one embodiment of the present application.

FIG. 5 illustrates a flowchart of wireless transmission according to one embodiment of the present application.

FIG. 6 illustrates a schematic diagram of determining a first link failure and a second link failure according to one embodiment of the present application.

FIG. 7 illustrates a schematic diagram of whether a second link recovery procedure is triggered according to one embodiment of the present application.

FIG. 8 illustrates a schematic diagram of whether a second link recovery procedure is triggered according to another embodiment of the present application.

FIG. 9 illustrates a schematic diagram of whether a second link recovery procedure is triggered according to another embodiment of the present application.

FIG. 10 illustrates a schematic diagram of whether a second link recovery procedure is triggered according to another embodiment of the present application.

FIG. 11 illustrates a schematic diagram of whether a second link recovery procedure is triggered according to another embodiment of the present application.

FIG. 12 illustrates a structure block diagram of a processing device in a first node according to one embodiment of the present application.

FIG. 13 illustrates a structure block diagram of a processing device used in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

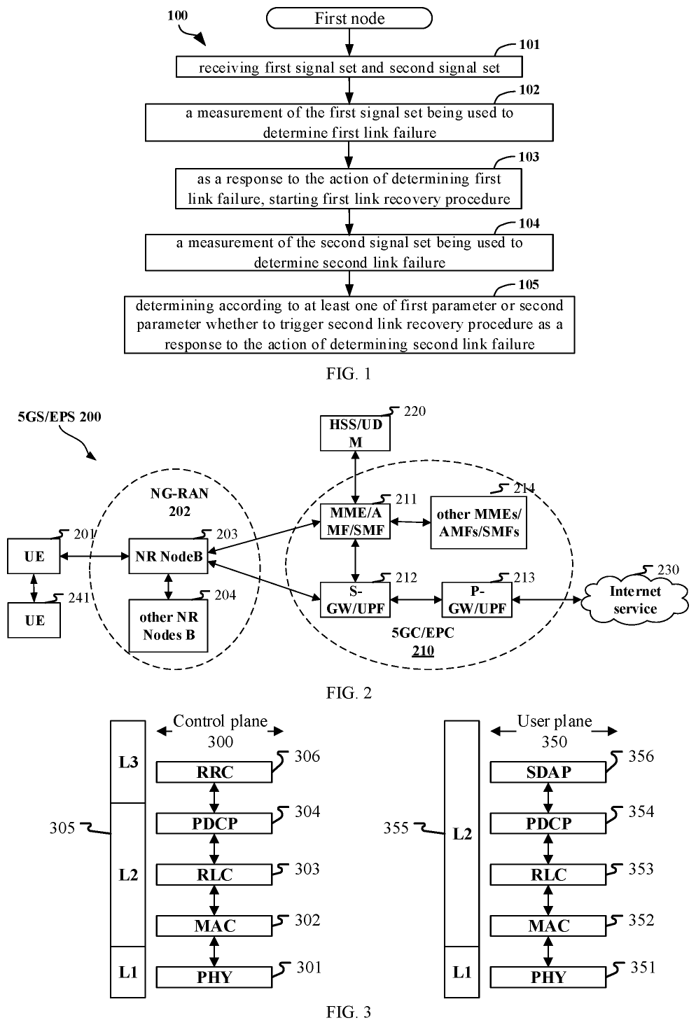

Embodiment 1 illustrates a flowchart of a first signal set, a second signal set, a first link failure and a second link failure according to one embodiment of the present application, as shown in FIG. 1. In 100 illustrated by FIG. 1, each box represents a step. Particularly, the sequential step arrangement in each box herein does not imply a chronological order of steps marked respectively by these boxes.

In Embodiment 1, the first node in the present application receives a first signal set and a second signal set in step 101; and a measurement of the first signal set being used to determine a first link failure in step 102; and as a response to the action of determining a first link failure, starts a first link recovery procedure in step 103; a measurement of the second signal set being used to determine a second link failure in step 104; and in step 105, determines according to at least one of a first parameter or a second parameter whether to trigger a second link recovery procedure as a response to the action of determining a second link failure; herein, each of the first signal set and the second signal set respectively comprises at least one reference signal associated with a first cell, and there exists at least one reference signal that only belongs to one of the first signal set or the second signal set; the first parameter is a time of the first link recovery procedure relative to the action of determining a second link failure, and the second parameter is whether the second link recovery procedure comprises a random access procedure.

In one embodiment, the step 102 is no later than the step 104 in time.

In one embodiment, the step 102 is earlier than the step 104 in time.

In one embodiment, the step 102 is later than the step 104 in time.

In one embodiment, the first signal set comprises a Channel State Information-Reference Signal (CSI-RS).

In one embodiment, the first signal set comprises a Periodic CSI-RS.

In one embodiment, the first signal set comprises at least one of a CSI-RS or a Synchronization Signal/Physical Broadcast CHannel (SS/PBCH) Block.

In one embodiment, the second signal set comprises a Channel State Information-Reference Signal (CSI-RS).

In one embodiment, the second signal set comprises a Periodic CSI-RS.

In one embodiment, the second signal set comprises at least one of a CSI-RS or a Synchronization Signal/Physical Broadcast CHannel (SS/PBCH) Block.

In one embodiment, the first signal set and the second signal set are used for Beam Failure Detection (BFD) in a Beam Failure Recovery (BFR) mechanism.

In one embodiment, for the detailed meaning of the beam failure recovery mechanism, refer to 3GPP TS38.213, Section 6.

In one embodiment, the first signal set is q̅₀.

In one embodiment, the second signal set is q̅₀.

In one embodiment, for the detailed meaning of the q̅₀, refer to 3GPP TS38.213, Section 6.

In one embodiment, the first signal set is configured by failureDetectionResources.

In one embodiment, the second signal set is configured by failureDetectionResources.

In one embodiment, for the detailed meaning of the failureDetectionResources, refer to 3GPP TS38.213, Section 6.

In one embodiment, the first signal set comprises reference signal(s) indicated by a Transmission Configuration Indicator (TCI) state of corresponding CORESET(s) used for monitoring a Physical Downlink Control CHannel (PDCCH).

In one embodiment, the second signal set comprises reference signal(s) indicated by a TCI state of corresponding CORESET(s) for monitoring a Physical Downlink Control CHannel (PDCCH).

In one embodiment, the first signal set comprises reference signal(s) indicated by a TCI state corresponding to a first COntrol REsource SET (CORESET) set, while the second signal set comprises reference signal(s) indicated by a TCI state corresponding to a second CORESETset.

In one embodiment, a name of an index of the first CORESET set includes CORESETPoolIndex, while a name of an index of the second CORESET set includes CORESETPoolIndex.

In one embodiment, a name of an index of the first CORESET set includes CORESET, while a name of an index of the second CORESET set includes CORESET.

In one embodiment, the first signal set comprises reference signal(s) indicated by a TCI state of CORESET(s) associated with a first search space set, while the second signal set comprises reference signal(s) indicated by a TCI state of CORESET(s) associated with a second search space set.

In one embodiment, the first CORESET set comprises at least one CORESET in the second CORESET set.

In one embodiment, the first CORESET set comprises the second CORESET set.

In one embodiment, any CORESET in the first CORESET set does not belong to the second CORESET set.

In one embodiment, the first search space set comprises at least one search space in the second search space set.

In one embodiment, the first search space set comprises the second search space set.

In one embodiment, any search space in the first search space set does not belong to the second search space set.

In one embodiment, a TCI state is used to indicate a positive integer number of reference signal(s).

In one embodiment, reference signal(s) indicated by a TCI state comprises/comprise at least one of a CSI-RS, an SRS or an SS/PBCH block.

In one embodiment, reference signal(s) indicated by a TCI state comprises/comprise a reference signal of which the type is QCL-TypeD.

In one embodiment, for the detailed meaning of the QCL-TypeD, refer to 3GPP TS38.214, Section 5.1.5.

In one embodiment, a reference signal indicated by a TCI state is used to determine a Quasi-Co-Located (QCL) parameter.

In one embodiment, a reference signal indicated by a TCI state is used to determine a spatial domain filter.

In one embodiment, a reference signal indicated by a TCI state is used to determine a spatial Reception parameter.

In one embodiment, a reference signal indicated by a TCI state is used to determine a spatial transmission parameter.

In one embodiment, the first cell is a SpCell.

In one embodiment, the first cell is a Primary Cell (PCell).

In one embodiment, the first cell is a Primary SCG Cell (PSCell).

In one embodiment, the first cell is a serving cell of the first node.

In one embodiment, the first signal set comprises a positive integer number of reference signal(s), and the second signal set comprises a positive integer number of reference signal(s).

In one embodiment, the reference signal is a CSI-RS resource or an SS/PBCH Block.

In one embodiment, the reference signal is a CSI-RS resource or an SS/PBCH Block indicated by an SS/PBCH Block index.

In one embodiment, the reference signal is a CSI-RS resource.

In one embodiment, the reference signal is an SS/PBCH Block.

In one embodiment, the reference signal is an SS/PBCH Block indicated by an SS/PBCH Block index.

In one embodiment, there exists at least one reference signal that belongs to both the first signal set and the second signal set.

In one embodiment, there exists at least one reference signal associated with a first cell that belongs to both the first signal set and the second signal set.

In one embodiment, the first signal set comprises at least one reference signal associated with a serving cell other than the first cell.

In one embodiment, the first signal set consists of reference signal(s) only associated with a first cell.

In one embodiment, the second signal set comprises at least one reference signal associated with a serving cell other than the first cell.

In one embodiment, the second signal set consists of reference signal(s) only associated with a first cell.

In one embodiment, there exists a reference signal that belongs to only the first signal set of the first signal set and the second signal set.

In one embodiment, the first signal set comprises the second signal set.

In one embodiment, the first signal set comprises at least one reference signal in the second signal set.

In one embodiment, any reference signal in the first signal set does not belong to the second signal set.

In one embodiment, the first signal set and the second signal set are respectively transmitted by different TRPs.

In one embodiment, at least one reference signal in the first signal set is transmitted by a same TRP as the second signal set.

In one embodiment, at least one reference signal in the first signal set is transmitted by a different TRP from the second signal set.

In one embodiment, the first signal set and the second signal set are configured by a same Information Element (IE).

In one embodiment, the first signal set and the second signal set are configured respectively by two IEs.

In one embodiment, a name of an IE for configuring the first signal set includes BeamFailureRecovery.

In one embodiment, a name of an IE for configuring the first signal set includes BeamFailure.

In one embodiment, a name of an IE for configuring the second signal set includes BeamFailureRecovery.

In one embodiment, a name of an IE for configuring the second signal set includes BeamFailure.

In one embodiment, the first signal set corresponds to a first index, while the second signal set corresponds to a second index, the first index and the second index being two non-negative integers different from each other.

In one embodiment, the first index and the second index respectively correspond to two TRPs of the first cell.

In one embodiment, the first index is an index of the first signal set, while the second index is an index of the second signal set.

In one embodiment, the first index is an index of the first CORESET set, while the second index is an index of the second CORESET set.

In one embodiment, the first index is an index of the first search space set, while the second index is an index of the second search space set.

In one embodiment, names of the first index include set, and names of the second index include set.

In one embodiment, names of the first index include SET, and names of the second index include SET.

In one embodiment, names of the first index include CORESETPoolIndex, and names of the second index include CORESETPoolIndex.

In one embodiment, names of the first index include CORESET, and names of the second index include CORESET.

In one embodiment, names of the first index include coreset, and names of the second index include coreset.

In one embodiment, names of the first index include TRP (i.e., Transmission and Reception Point), and names of the second index include TRP.

In one embodiment, names of the first index include TCI, and names of the second index include TCI.

In one embodiment, names of the first index include tci, and names of the second index include tci.

In one embodiment, the sentence that “a given reference signal is associated with a given cell” means that: a Physical Cell Identity (PCI) of the given cell is used for generating the given reference signal.

In one subembodiment, the given cell is the first cell, and the given reference signal is a reference signal associated with the first cell.

In one subembodiment, the given cell is a serving cell other than the first cell, and the given reference signal is a reference signal associated with the given cell.

In one embodiment, the sentence that “a given reference signal is associated with a given cell” means that: the given reference signal and an SSB of the given cell are QCL.

In one subembodiment, the given cell is the first cell, and the given reference signal is a reference signal associated with the first cell.

In one subembodiment, the given cell is a serving cell other than the first cell, and the given reference signal is a reference signal associated with the given cell.

In one embodiment, the sentence that “a given reference signal is associated with a given cell” means that: the given reference signal is transmitted by the given cell.

In one subembodiment, the given cell is the first cell, and the given reference signal is a reference signal associated with the first cell.

In one subembodiment, the given cell is a serving cell other than the first cell, and the given reference signal is a reference signal associated with the given cell.

In one embodiment, the sentence that “a given reference signal is associated with a given cell” means that:
a radio resource occupied by the given reference signal is indicated by a configuration signaling, and a Radio Link Control (RLC) Bearer through which the configuration signaling is conveyed is configured via a CellGroupConfig IE, where a Special cell (SpCell) or Secondary Cell (SCell) configured by the CellGroupConfig IE includes the given cell.

In one subembodiment, the given cell is the first cell, and the given reference signal is a reference signal associated with the first cell.

In one subembodiment, the given cell is a serving cell other than the first cell, and the given reference signal is a reference signal associated with the given cell.

In one embodiment, the sentence that “a given reference signal is associated with a given cell” means that: a radio resource occupied by the given reference signal is indicated by a configuration signaling, and a Radio Link Control (RLC) Bearer through which the configuration signaling is conveyed is configured via a CellGroupConfig IE, where a Special cell (Spcell) configured by the CellGroupConfig IE includes the given cell.

In one subembodiment, the given cell is the first cell, and the given reference signal is a reference signal associated with the first cell.

In one subembodiment, the given cell is a serving cell other than the first cell, and the given reference signal is a reference signal associated with the given cell.

In one embodiment, the configuration signaling comprises a higher-layer signaling.

In one embodiment, the configuration signaling comprises an RRC signaling.

In one embodiment, the method in the first node comprises:
receiving a first information group;
herein, the first information group is used to indicate the first signal set.

In one embodiment, the first receiver receives a first information group; herein, the first information group is used to indicate the first signal set.

In one embodiment, the method in the first node comprises:
receiving a second information group;
herein, the second information group is used to indicate the second signal set.

In one embodiment, the first receiver receives a second information group; herein, the second information group is used to indicate the second signal set.

In one embodiment, the first information group is carried by an RRC signaling.

In one embodiment, the second information group is carried by an RRC signaling.

In one embodiment, the first information group comprises all or partial fields in an IE.

In one embodiment, the second information group comprises all or partial fields in an IE.

In one embodiment, the first information group and the second information group belong to a same IE.

In one embodiment, the first information group and the second information group respectively comprise two IEs.

In one embodiment, the first information group explicitly indicates the first signal set.

In one embodiment, the first information group implicitly indicates the first signal set.

In one embodiment, the first information group indicates a Transmission Configuration Indicator (TCI) state of corresponding CORESET(s) used for monitoring a Physical Downlink Control CHannel (PDCCH).

In one embodiment, the first information group indicates an index of each reference signal in the first signal set.

In one embodiment, the first information group comprises configuration information of each reference signal in the first signal set.

In one embodiment, configuration information of any reference signal in the first signal set comprises at least one of a periodicity, a time-domain offset, occupied time-domain resources, occupied frequency-domain resources, occupied code-domain resources, a cyclic shift, an Orthogonal Cover Code (OCC), an occupied antenna port group, a sequence, a TCI state, a spatial-domain filter, a spatial Rx parameter or a spatial Tx parameter.

In one embodiment, the first information group comprises S1 information blocks, and the first signal set comprises S1 reference signals, where the S1 information blocks are respectively used for indicating the S1 reference signals, S1 being a positive integer greater than 1.

In one embodiment, the second information group explicitly indicates the second signal set.

In one embodiment, the second information group implicitly indicates the second signal set.

In one embodiment, the second information group indicates a TCI state of corresponding CORESET(s) used for monitoring a Physical Downlink Control CHannel (PDCCH).

In one embodiment, the first information group indicates a first CORESET set, while the second information group indicates a second CORESET set.

In one embodiment, the first information group indicates a TCI state corresponding to a first CORESET set, while the second information group indicates a TCI state corresponding a second CORESET set.

In one embodiment, the first information group indicates a first search space set, while the second information group indicates a second search space set.

In one embodiment, the second information group indicates an index of each reference signal in the second signal set.

In one embodiment, the second information group comprises configuration information of each reference signal in the second signal set.

In one embodiment, configuration information of any reference signal in the second signal set comprises at least one of a periodicity, a time-domain offset, occupied time-domain resources, occupied frequency-domain resources, occupied code-domain resources, a cyclic shift, an Orthogonal Cover Code (OCC), an occupied antenna port group, a sequence, a TCI state, a spatial-domain filter, a spatial Rx parameter or a spatial Tx parameter.

In one embodiment, the second information group comprises S2 information blocks, and the second signal set comprises S2 reference signals, where the S2 information blocks are respectively used for indicating the S2 reference signals, S2 being a positive integer greater than 1.

In one embodiment, determining according to a first parameter whether to trigger a second link recovery procedure as a response to the action of determining a second link failure.

In one embodiment, determining according to a second parameter whether to trigger a second link recovery procedure as a response to the action of determining a second link failure.

In one embodiment, determining according to a first parameter and a second parameter whether to trigger a second link recovery procedure as a response to the action of determining a second link failure.

In one embodiment, determining whether to trigger a second link recovery procedure as a response to the action of determining a second link failure according to other parameter(s) other than a first parameter and a second parameter.

In one embodiment, determining whether to trigger a second link recovery procedure as a response to the action of determining a second link failure according to at least one of a first parameter or a second parameter as well as other parameter(s) other than the first parameter and the second parameter.

In one embodiment, determining whether to trigger a second link recovery procedure as a response to the action of determining a second link failure only according to at least one of a first parameter or a second parameter.

In one embodiment, when a result of the action of “determining whether to trigger a second link recovery procedure as a response to the action of determining a second link failure” is yes, trigger the second link recovery procedure; when a result of the action of “determining whether to trigger a second link recovery procedure as a response to the action of determining a second link failure” is no, drop triggering the second link recovery procedure.

In one embodiment, the phrase “the time of the first link recovery procedure relative to the action of determining a second link failure” means: whether the first link recovery procedure is earlier or later than the action of determining a second link failure.

In one embodiment, the phrase “the time of the first link recovery procedure relative to the action of determining a second link failure” means: whether the first link recovery procedure is before or after the action of determining a second link failure in time.

In one embodiment, the phrase “the time of the first link recovery procedure relative to the action of determining a second link failure” means: whether a start time of the first link recovery procedure is earlier or later than the action of determining a second link failure.

In one embodiment, the phrase “the time of the first link recovery procedure relative to the action of determining a second link failure” means: whether a start time of the first link recovery procedure is before or after the action of determining a second link failure in time.

In one embodiment, the phrase “the time of the first link recovery procedure relative to the action of determining a second link failure” means: whether the first link recovery procedure is successfully completed before the action of determining a second link failure.

In one embodiment, the phrase that “whether the second link recovery procedure comprises a random access procedure” means: whether the second link recovery procedure comprises a 4-step random access procedure.

In one embodiment, the phrase that “whether the second link recovery procedure comprises a random access procedure” means: whether the second link recovery procedure comprises a 2-step random access procedure.

In one embodiment, the phrase that “whether the second link recovery procedure comprises a random access procedure” means: whether the second link recovery procedure comprises a Contention Free Random Access (CFRA).

In one embodiment, the phrase that “whether the second link recovery procedure comprises a random access procedure” means: whether the second link recovery procedure comprises a Contention Based Random Access (CBRA).

In one embodiment, the random access procedure is a CFRA.

In one embodiment, the random access procedure is a CBRA.

In one embodiment, the random access procedure is a 4-step Random Access (RA) procedure.

In one embodiment, the random access procedure is a 2-step Random Access (RA) procedure.

In one embodiment, the random access procedure is Contention-Free.

In one embodiment, the random access procedure is Contention-based.

In one embodiment, the random access procedure comprises transmitting a random access preamble.

### Embodiment 2

Embodiment 2 illustrates a schematic diagram of a network architecture according to one embodiment of the present application, as shown in FIG. 2.

FIG. 2 is a diagram illustrating a network architecture of Long-Term Evolution (LTE), Long-Term Evolution Advanced (LTE-A) and future 5G systems. The LTE, or LTE-A or future 5G network architecture 200 may be called an Evolved Packet System (EPS) 200. The 5G NR or LTE network 200 can be called a 5G System/Evolved Packet System (5GS/EPS) 200 or other appropriate terms. The 5GS/EPS 200 may comprise one or more UEs 201, a UE 241 in sidelink communication with the UE(s) 201, an NG-RAN 202, a 5G CoreNetwork/Evolved Packet Core (5GC/EPC) 210, a Home Subscriber Server/Unified Data Management (HSS/UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will find it easy to understand that various concepts presented throughout the present application can be extended to networks providing circuit switching services or other cellular networks. The NG-RAN202 comprises a New Radio (NR) node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the 5G-CN/EPC 210 for the UE 201. Examples of UE 201 include cellular phones, smart phones, Session Initiation Protocol (SIP) phones, laptop computers, Personal Digital Assistant (PDA), Satellite Radios, Global Positioning System (GPS), multimedia devices, video devices, digital audio players (for example, MP3 players), cameras, games consoles, unmanned aerial vehicles, air vehicles, narrow-band physical network equipment, machine-type communication equipment, land vehicles, automobiles, wearables, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected with the 5G-CN/EPC 210 via an S1/NG interface. The 5G-CN/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212. The S-GW/UPF 212 is connected to the P-GW/UPF 213. The P-GW 213 provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching (PS) services.

In one embodiment, the first node in the present application includes the UE 201.

In one embodiment, the first node in the present application includes the UE 241.

In one embodiment, the second node in the present application includes the gNB203.

### Embodiment 3

Embodiment 3 illustrates a schematic diagram of an example of a radio protocol architecture of a user plane and a control plane according to the present application, as shown in FIG. 3.

Embodiment 3 illustrates a schematic diagram of a radio protocol architecture of a user plane and a control plane according to the present application, as shown in FIG. 3. FIG. 3 is a schematic diagram illustrating an embodiment of a radio protocol architecture of a user plane 350 and a control plane 300. In FIG. 3, the radio protocol architecture for a control plane 300 between a first communication node (UE, gNB or, RSU in V2X) and a second communication node (gNB, UE, or RSU in V2X), or between two UEs, is represented by three layers, which are a layer 1, a layer 2 and a layer 3, respectively. The layer 1 (L1) is the lowest layer which performs signal processing functions of various PHY layers. The L1 is called PHY 301 in the present application. The layer 2 (L2) 305 is above the PHY 301, and is in charge of the link between the first communication node and the second communication node or between two UEs. The L2 305 comprises a Medium Access Control (MAC) sublayer 302, a Radio Link Control (RLC) sublayer 303 and a Packet Data Convergence Protocol (PDCP) sublayer 304. All the three sublayers terminate at the second communication nodes of the network side. The PDCP sublayer 304 provides multiplexing among variable radio bearers and logical channels. The PDCP sublayer 304 provides security by encrypting a packet and provides support for handover of a first communication node between second communication nodes. The RLC sublayer 303 provides segmentation and reassembling of a higher-layer packet, retransmission of a lost packet, and reordering of a packet so as to compensate the disordered receiving caused by Hybrid Automatic Repeat reQuest (HARQ). The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. In the control plane 300, The RRC sublayer 306 in the L3 layer is responsible for acquiring radio resources (i.e., radio bearer) and configuring the lower layer using an RRC signaling between the second communication node and the first communication node. The radio protocol architecture in the user plane 350 comprises the L1 layer and the L2 layer. In the user plane 350, the radio protocol architecture used for the first communication node and the second communication node in a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between QoS streams and a Data Radio Bearer (DRB), so as to support diversified traffics. Although not described in FIG. 3, the first communication node may comprise several higher layers above the L2 355, such as a network layer (i.e., IP layer) terminated at a P-GW 213 of the network side and an application layer terminated at the other side of the connection (i.e., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the first signal set and the second signal set are generated by the PHY301.

In one embodiment, the first signal set and the second signal set are generated by the PHY351.

In one embodiment, the first link failure is determined in the MAC sublayer 302.

In one embodiment, the first link failure is determined in the MAC sublayer 352.

In one embodiment, the second link failure is determined in the MAC sublayer 302.

In one embodiment, the second link failure is determined in the MAC sublayer 352.

### Embodiment 4

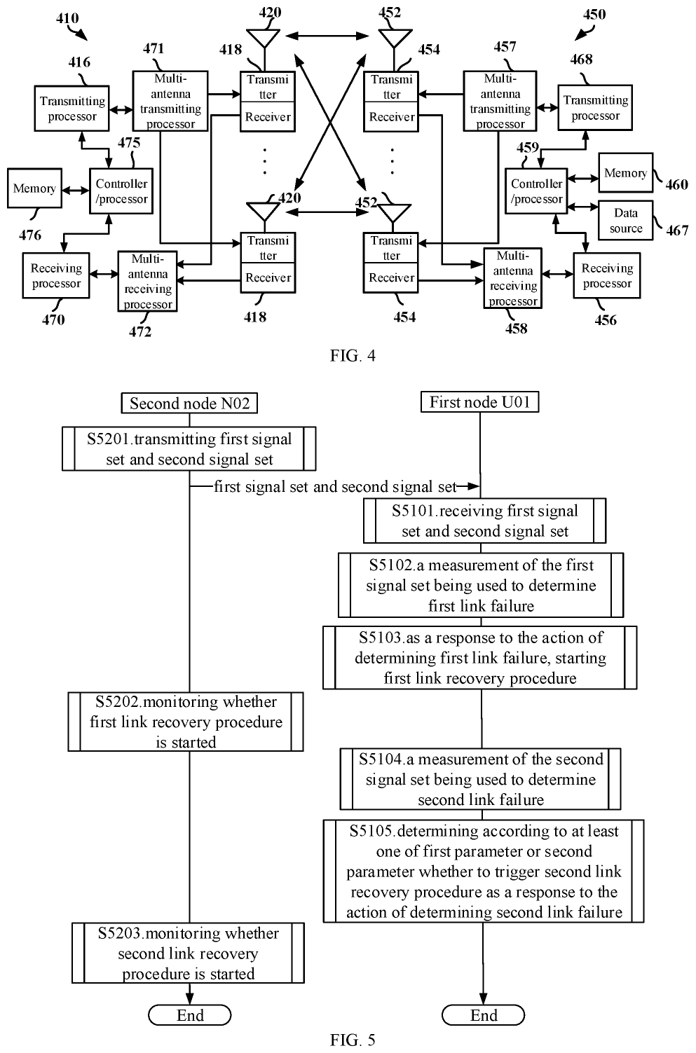

Embodiment 4 illustrates a schematic diagram of a first communication device and a second communication device according to one embodiment of the present application, as shown in FIG. 4. FIG. 4 is a block diagram of a first communication device 410 and a second communication device 450 in communication with each other in an access network.

The first communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

The second communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

In a transmission from the first communication device 410 to the second communication device 450, at the first communication device 410, a higher layer packet from a core network is provided to the controller/processor 475. The controller/processor 475 provides functions of the L2 layer. In DL, the controller/processor 475 provides header compression, encryption, packet segmentation and reordering, multiplexing between a logical channel and a transport channel and radio resource allocation of the second communication device 450 based on various priorities. The controller/processor 475 is responsible for HARQ operation, retransmission of a lost packet and a signaling to the second communication device 450. The transmitting processor 416 and the multi-antenna transmitting processor 471 perform various signal processing functions used for the L1 layer (i.e., PHY). The transmitting processor 416 performs coding and interleaving so as to ensure a Forward Error Correction (FEC) at the second communication device 450 side and the constellation mapping corresponding to each modulation scheme (i.e., BPSK, QPSK, M-PSK, and M-QAM, etc.). The multi-antenna transmitting processor 471 performs digital spatial precoding, which includes precoding based on codebook and precoding based on non-codebook, and beamforming processing on encoded and modulated signals to generate one or more parallel streams. The transmitting processor 416 then maps each parallel stream into a subcarrier. The modulated symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to different antennas 420.

In a transmission from the first communication device 410 to the second communication device 450, at the second communication device 450, each receiver 454 receives a signal via a corresponding antenna 452. Each receiver 454 recovers information modulated to the RF carrier, and converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs reception analog precoding/beamforming on a baseband multicarrier symbol stream provided by the receiver 454. The receiving processor 456 converts baseband multicarrier symbol streams which have gone through reception analog precoding/beamforming operations from time domain to frequency domain using FFT. In frequency domain, physical layer data signals and reference signals are de-multiplexed by the receiving processor 456, where the reference signals are used for channel estimation while data signals are processed in the multi-antenna receiving processor 458 by multi-antenna detection to recover any parallel stream targeting the second communication device 450. Symbols on each parallel stream are demodulated and recovered in the receiving processor 456 to generate a soft decision. Then the receiving processor 456 decodes and de-interleaves the soft decision to recover the higher-layer data and control signal transmitted by the first communication device 410 on the physical channel. Next, the higher-layer data and control signal are provided to the controller/processor 459. The controller/processor 459 provides functions of the L2 layer. The controller/processor 459 can be associated with a memory 460 that stores program code and data. The memory 460 can be called a computer readable medium. In DL transmission, the controller/processor 459 provides de-multiplexing between a transport channel and a logical channel, packet reassembling, decryption, header decompression, control signal processing so as to recover a higher-layer packet from the core network. The higher-layer packet is later provided to all protocol layers above the L2 layer. Or various control signals can be provided to the L3 for processing. The controller/processor 459 is also in charge of using ACK and/or NACK protocols for error detection as a way to support HARQ operation.

In a transmission from the second communication device 450 to the first communication device 410, at the second communication device 450, the data source 467 is configured to provide a higher-layer packet to the controller/processor 459. The data source 467 represents all protocol layers above the L2 layer. Similar to a transmitting function of the first communication device 410 described in DL, the controller/processor 459 performs header compression, encryption, packet segmentation and reordering, and multiplexing between a logical channel and a transport channel based on radio resource allocation for the first communication device 410 so as to provide the L2 layer functions used for the user plane and the control plane. The controller/processor 459 is responsible for HARQ operation, retransmission of a lost packet and a signaling to the first communication device 410. The transmitting processor 468 performs modulation and mapping, as well as channel coding, and the multi-antenna transmitting processor 457 performs digital multi-antenna spatial precoding, including precoding based on codebook and precoding based on non-codebook, and beamforming. The transmitting processor 468 then modulates generated parallel streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 first converts a baseband symbol stream provided by the multi-antenna transmitting processor 457 into a radio frequency symbol stream, and then provides the radio frequency symbol stream to the antenna 452.

In a transmission from the second communication device 450 to the first communication device 410, the function of the first communication device 410 is similar to the receiving function of the second communication device 450 described in the transmission from the first communication device 410 to the second communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the L1 layer. The controller/processor 475 provides functions of the L2 layer. The controller/processor 475 can be associated with the memory 476 that stores program code and data. The memory 476 can be called a computer readable medium. The controller/processor 475 provides demultiplexing between a transport channel and a logical channel, packet reassembling, decryption, header decompression and control signal processing so as to recover a higher-layer packet from the second communication device 450. The higher-layer packet coming from the controller/processor 475 may be provided to the core network. The controller/processor 475 can also perform error detection using ACK and/or NACK protocols to support HARQ operation.

In one embodiment, the second communication device 450 comprises at least one processor and at least one memory, the at least one memory comprises computer program codes; the at least one memory and the computer program codes are configured to be used in collaboration with the at least one processor. The second communication device 450 at least: receives a first signal set and a second signal set; a measurement of the first signal set being used to determine a first link failure; and a measurement of the second signal set being used to determine a second link failure; and as a response to the action of determining a first link failure, starts a first link recovery procedure; and determining according to at least one of a first parameter or a second parameter whether to trigger a second link recovery procedure as a response to the action of determining a second link failure; herein, each of the first signal set and the second signal set respectively comprises at least one reference signal associated with a first cell, and there exists at least one reference signal that only belongs to one of the first signal set or the second signal set; the first parameter is a time of the first link recovery procedure relative to the action of determining a second link failure, and the second parameter is whether the second link recovery procedure comprises a random access procedure.

In one embodiment, the second communication device 450 comprises a memory that stores a computer readable instruction program, the computer readable instruction program generates actions when executed by at least one processor, which include: receiving a first signal set and a second signal set; a measurement of the first signal set being used to determine a first link failure; and a measurement of the second signal set being used to determine a second link failure; and as a response to the action of determining a first link failure, starting a first link recovery procedure; and determining according to at least one of a first parameter or a second parameter whether to trigger a second link recovery procedure as a response to the action of determining a second link failure; herein, each of the first signal set and the second signal set respectively comprises at least one reference signal associated with a first cell, and there exists at least one reference signal that only belongs to one of the first signal set or the second signal set; the first parameter is a time of the first link recovery procedure relative to the action of determining a second link failure, and the second parameter is whether the second link recovery procedure comprises a random access procedure.

In one embodiment, the first communication device 410 comprises at least one processor and at least one memory, the at least one memory comprises computer program codes; the at least one memory and the computer program codes are configured to be used in collaboration with the at least one processor. The first communication device 410 at least: transmits a first signal set and a second signal set; and monitors whether a first link recovery procedure is started; herein, when a measurement of the first signal set is used to determine a first link failure, the first link recovery procedure is started; when a measurement of the second signal set is used to determine a second link failure, at least one of a first parameter or a second parameter is used to determine whether a second link recovery procedure is triggered; each of the first signal set and the second signal set respectively comprises at least one reference signal associated with a first cell, and there exists at least one reference signal that only belongs to one of the first signal set or the second signal set; the first parameter is a time of the first link recovery procedure relative to the action of determining a second link failure, and the second parameter is whether the second link recovery procedure comprises a random access procedure.

In one embodiment, the first communication device 410 comprises a memory that stores a computer readable instruction program, the computer readable instruction program generates actions when executed by at least one processor, which include: transmitting a first signal set and a second signal set; and monitoring whether a first link recovery procedure is started; herein, when a measurement of the first signal set is used to determine a first link failure, the first link recovery procedure is started; when a measurement of the second signal set is used to determine a second link failure, at least one of a first parameter or a second parameter is used to determine whether a second link recovery procedure is triggered; each of the first signal set and the second signal set respectively comprises at least one reference signal associated with a first cell, and there exists at least one reference signal that only belongs to one of the first signal set or the second signal set; the first parameter is a time of the first link recovery procedure relative to the action of determining a second link failure, and the second parameter is whether the second link recovery procedure comprises a random access procedure.

In one embodiment, the first node in the present application comprises the second communication device 450.

In one embodiment, the second node in the present application comprises the first communication device 410.

In one embodiment, at least one of the antenna 452, the receiver 454, the receiving processor 456, the multi-antenna receiving processor 458, the controller/processor 459, the memory 460 or the data source 467 is used to receive a first signal set and a second signal set.

In one embodiment, at least one of the antenna 452, the receiver 454, the receiving processor 456, the multi-antenna receiving processor 458, the controller/processor 459, the memory 460 or the data source 467 is used to determine a first link failure and a second link failure.

In one embodiment, at least one of the antenna 420, the transmitter 418, the transmitting processor 416, the multi-antenna transmitting processor 471, the controller/processor 475 or the memory 476 is used to transmit a first signal set and a second signal set.

In one embodiment, at least one of the antenna 452, the transmitter/receiver 454, the transmitting processor 468, the multi-antenna transmitting processor 457, the receiving processor 456, the multi-antenna receiving processor 458, the controller/processor 459, the memory 460 or the data source 467 is used to start a first link recovery procedure.

In one embodiment, at least one of the antenna 420, the transmitter/receiver 418, the receiving processor 470, the multi-antenna receiving processor 472, the transmitting processor 416, the multi-antenna transmitting processor 471, the controller/processor 475 or the memory 476 is used to monitor whether a first link recovery procedure is started.

In one embodiment, at least one of the antenna 452, the transmitter/receiver 454, the transmitting processor 468, the multi-antenna transmitting processor 457, the receiving processor 456, the multi-antenna receiving processor 458, the controller/processor 459, the memory 460 or the data source 467 is used to determine whether to trigger a second link recovery procedure as a response to the action of determining a second link failure.

In one embodiment, at least one of the antenna 420, the transmitter/receiver 418, the receiving processor 470, the multi-antenna receiving processor 472, the transmitting processor 416, the multi-antenna transmitting processor 471, the controller/processor 475 or the memory 476 is used to monitor whether a second link recovery procedure is started.

### Embodiment 5

Embodiment 5 illustrates a flowchart of wireless transmission according to one embodiment of the present application, as shown in FIG. 5. In FIG. 5, a first node U01 and a second node N02 are communication nodes that mutually transmit to each other via an air interface.

The first node U01 receives a first signal set and a second signal set in step S5101; a measurement of the first signal set being used to determine a first link failure in step S5102; and as a response to the action of determining a first link failure, starts a first link recovery procedure in step S5103; a measurement of the second signal set being used to determine a second link failure in step S5104; and in step S5105, determines according to at least one of a first parameter or a second parameter whether to trigger a second link recovery procedure as a response to the action of determining a second link failure;

the second node N02 transmits a first signal set and a second signal set in step S5201; monitors whether a first link recovery procedure is started in step S5202; and monitors whether a second link recovery procedure is started in step S5203.

In Embodiment 5, each of the first signal set and the second signal set respectively comprises at least one reference signal associated with a first cell, and there exists at least one reference signal that only belongs to one of the first signal set or the second signal set; the first parameter is a time of the first link recovery procedure relative to the action of determining a second link failure, and the second parameter is whether the second link recovery procedure comprises a random access procedure.

In one embodiment, the step S102 is no later than the step S104 in time.

In one embodiment, the step S102 is earlier than the step S104 in time.

In one embodiment, the step S102 is later than the step S104 in time.

In one embodiment, a measurement of the first signal set is used by the first node U01 to determine a first link failure; a measurement of the second signal set is used by the first node U01 to determine a second link failure.

In one embodiment, the first node U01 determines whether to trigger a second link recovery procedure as a response to the action of determining a second link failure according to at least one of a first parameter or a second parameter.

In one embodiment, the first link failure comprises a Beam Failure (BF).

In one embodiment, the first link failure comprises BFI_COUNTER>=beamFailureInstanceMaxCount.

In one embodiment, the first link failure comprises a first counter being no less than a first value.

In one embodiment, the first link failure comprises a Radio Link Failure (RLF).

In one embodiment, the first link failure comprises a downlink control channel failure of the first cell.

In one embodiment, the first link failure comprises a PDCCH failure of the first cell.

In one embodiment, the second link failure comprises a Beam Failure (BF).

In one embodiment, the second link failure comprises a second counter being no less than a second value.

In one embodiment, the second link failure comprises BFI_COUNTER>=beamFailureInstanceMaxCount.

In one embodiment, there exists no other link recovery procedure for the first cell between the first link recovery procedure and the second link recovery procedure.

In one embodiment, only one of the first link recovery procedure or the second link recovery procedure comprises a random access procedure.

In one embodiment, at least the first link recovery procedure of the first link recovery procedure or the second link recovery procedure comprises a random access procedure.

In one embodiment, the first link recovery procedure comprises transmitting a random access preamble.

In one embodiment, the first link recovery procedure comprises a first random access procedure.

In one embodiment, the first random access procedure is a Contention Based Random Access (CBRA) procedure.

In one embodiment, the first random access procedure is a Contention Free Random Access (CFRA).

In one embodiment, the first random access procedure includes a 4-step Random Access (RA) procedure.

In one embodiment, the first random access procedure includes a 2-step Random Access (RA) procedure.

In one embodiment, the first link recovery procedure comprises transmitting a first message.

In one embodiment, the first link recovery procedure comprises a Beam Failure Recovery (BFR).

In one embodiment, the second link recovery procedure comprises triggering a Buffer Status Report (BSR).

In one embodiment, the second link recovery procedure comprises a second random access procedure.

In one embodiment, the second random access procedure is a Contention Based Random Access (CBRA) procedure.

In one embodiment, the second random access procedure is a Contention Free Random Access (CFRA).

In one embodiment, the second random access procedure includes a 4-step Random Access (RA) procedure.

In one embodiment, the second random access procedure includes a 2-step Random Access (RA) procedure.

In one embodiment, the second link recovery procedure comprises transmitting a second message.

In one embodiment, the second link recovery procedure comprises a Scheduling Request (SR).

In one embodiment, the second link recovery procedure comprises a Scheduling Request (SR) and a BFR MAC CE.

In one embodiment, when a failure occurs in at least the first link recovery procedure of the first link recovery procedure or the second link recovery procedure, a Radio Link Failure (RLF) of the first cell is triggered.

In one embodiment, when a failure occurs in the first link recovery procedure or the second link recovery procedure, a Radio Link Failure (RLF) of the first cell is triggered.

In one embodiment, when a failure occurs in the first link recovery procedure and the second link recovery procedure, a Radio Link Failure (RLF) of the first cell is triggered.

In one embodiment, at least the second link recovery procedure of the first link recovery procedure or the second link recovery procedure comprises a BFR MAC CE or a Truncated BFR MAC CE.

In one embodiment, at least the second link recovery procedure of the first link recovery procedure or the second link recovery procedure comprises a Contention Based Random Access (CBRA) procedure.

In one embodiment, only the second link recovery procedure of the first link recovery procedure or the second link recovery procedure comprises a Contention Free Random Access (CFRA) procedure.

In one embodiment, the first link recovery procedure comprises a Contention Based Random Access (CBRA) procedure or a Contention Free Random Access (CFRA) procedure, while the second link recovery procedure comprises a CBRA procedure.

In one embodiment, the first link recovery procedure comprises a Contention Based Random Access (CBRA) procedure or a Contention Free Random Access (CFRA) procedure, while the second link recovery procedure comprises a Scheduling Request (SR).

In one embodiment, the first link failure is used to trigger the first signal.

In one embodiment, the first link failure is used to trigger generation of a first message.

In one embodiment, the first message is used to trigger the first signal.

In one embodiment, the first message comprises a MAC CE.

In one embodiment, the first message comprises a PUSCH MAC CE.

In one embodiment, the first message comprises a Beam Failure Recovery (BFR) MAC CE.

In one embodiment, the first message comprises a Truncated BFR MAC CE.

In one embodiment, the first message comprises a first field.

In one embodiment, the first field comprises a positive integer number of bit(s).

In one embodiment, the first field comprises one bit.

In one embodiment, a value of the first field in the first message is equal to 1.

In one embodiment, the first field is an SP Field.

In one embodiment, for the detailed meaning of the SP Field, refer to 3GPP TS38.321, Section 6.1.3.

In one embodiment, the first message comprises a second field.

In one embodiment, the second field in the first message is used to determine the first index.

In one embodiment, the second field in the first message is used to indicate the first index.

In one embodiment, the second field in the first message explicitly indicates the first index.

In one embodiment, the second field in the first message implicitly indicates the first index.

In one embodiment, the first link recovery procedure comprises: the first transceiver transmitting a first signal in a first radio resource group.

In one embodiment, the first link recovery procedure comprises: the second transceiver monitoring in a first radio resource set whether there is any radio signal being transmitted.

In one embodiment, the first link recovery procedure comprises: the second transceiver monitoring in a first radio resource group whether a first signal is transmitted.

In one embodiment, the meaning of the action of monitoring whether a first link recovery procedure is started comprises: the second transceiver monitoring in the first radio resource set whether there is any radio signal being transmitted.

In one embodiment, the meaning of the action of monitoring whether a first link recovery procedure is started comprises: the second transceiver monitoring in the first radio resource group whether the first signal is transmitted.

In one embodiment, the first radio resource group comprises a positive integer number of radio resource(s).

In one embodiment, the radio resource comprises at least one of a time-frequency resource or a code-domain resource.

In one embodiment, the radio resource comprises a time-frequency resource.

In one embodiment, the radio resource comprises a code-domain resource.

In one embodiment, the radio resource comprises a time-frequency resource and a code-domain resource.

In one embodiment, the code-domain resource comprises one or more of an RS sequence, a Preamble, a pseudo-random sequence, a low-PAPR sequence, a cyclic shift, an Orthogonal Cover Code (OCC), an orthogonal sequence, a frequency-domain orthogonal sequence or a time-domain orthogonal sequence.

In one embodiment, the first signal comprises a Random Access Preamble.

In one embodiment, the first signal comprises a first characteristic sequence.

In one embodiment, the first characteristic sequence comprises one or more of a pseudo-random sequence, a Zadoff-Chu sequence or a low-Peak-to-Average Power Ratio (low-PAPR) sequence.

In one embodiment, the first characteristic sequence comprises Cyclic Prefix (CP).

In one embodiment, the first radio resource group comprises at least a Physical Random Access CHannel (PRACH) resource out of the PRACH resource or a radio resource occupied by a PUSCH scheduled by a Random Access Response (RAR) UL grant.

In one embodiment, the first radio resource group comprises a PRACH resource.

In one embodiment, the first radio resource group comprises a PRACH resource and a radio resource occupied by a PUSCH scheduled by a RAR UL grant.

In one embodiment, the first radio resource group is configured by a higher layer parameter.

In one embodiment, the first radio resource group is configured by a PRACH-ResourceDedicatedBFR.

In one embodiment, the first radio resource group comprises a first radio resource block and a second radio resource block, and the first signal comprises a first sub-signal and a second sub-signal, where the first radio resource block comprises a radio resource occupied by the first sub-signal, while the second radio resource block comprises a radio resource occupied by the second sub-signal.

In one embodiment, the first sub-signal comprises a first characteristic sequence.

In one embodiment, the first sub-signal comprises a Random Access Preamble.

In one embodiment, the second sub-signal comprises a Medium Access Control layer Control Element (MAC CE).

In one embodiment, the second sub-signal comprises a Beam Failure Recovery (BFR) MAC CE.

In one embodiment, the second sub-signal comprises a Truncated BFR MAC CE.

In one embodiment, the second sub-signal bears a first message.

In one embodiment, the first sub-signal comprises an Msg1, while the second sub-signal comprises an Msg3 PUSCH.

In one embodiment, the first sub-signal comprises an Msg1, while the second sub-signal comprises a PUSCH scheduled by a RAR UL grant.

In one embodiment, the first signal comprises an MsgA, the first sub-signal comprises a random access preamble in the MsgA, while the second sub-signal comprises a PUSCH in the MsgA.

In one embodiment, the first radio resource block comprises a PRACH resource.

In one embodiment, the first radio resource block comprises a PRACH-ResourceDedicatedBFR.

In one embodiment, the second radio resource block comprises a PUSCH resource.

In one embodiment, the first link recovery procedure comprises: the first transceiver monitoring a response to the first signal in a third radio resource group; herein, the third radio resource group belongs to a first time window in time domain, where a start of the first time window is later than an end time of the first radio resource group.

In one embodiment, the first link recovery procedure comprises: the second transceiver transmitting a response to the first signal in a third radio resource group; herein, the third radio resource group belongs to a first time window in time domain, where a start of the first time window is later than an end time of the first radio resource group.

In one embodiment, the first time window comprises contiguous time-domain resources.

In one embodiment, a duration of the first time window is configured by a higher layer signaling.

In one embodiment, a duration of the first time window is configured by a BeamFailureRecoveryConfig IE.

In one embodiment, a duration of the first time window is configured by a beamFailureRecoveryTimer.

In one embodiment, a duration of the first time window is configured by a ra-ContentionResolutionTimer.

In one embodiment, the third radio resource group comprises a positive integer number of radio resource(s).

In one embodiment, the third radio resource group comprises a search space.

In one embodiment, the third radio resource group comprises a search space set.

In one embodiment, the third radio resource group comprises one or more Physical Downlink Control Channel (PDCCH) candidates.

In one embodiment, the third radio resource group comprises a COntrol REsource SET (CORESET).

In one embodiment, a search space set to which the third radio resource group belongs is identified by a recoverySearchSpaceId.

In one embodiment, an index of a search space set to which the third radio resource group belongs is equal to 0.

In one embodiment, a search space set to which the third radio resource group belongs includes a Type1-PDCCH Common search space (CSS) set.

In one embodiment, the third radio resource group belongs to a PDCCH Common search space (CSS) set.

In one embodiment, the third radio resource group is associated with the first index.

In one embodiment, the response to the first signal comprises a higher layer activation command for a TCI state.

In one embodiment, the response to the first signal comprises an activation command for a higher-layer parameter tci-StatesPDCCH-ToAddList and/or a higher-layer parameter tci-StatesPDCCH-ToReleaseList.

In one embodiment, the response to the first signal comprises a MAC CE used for indicating a PDCCH TCI.

In one embodiment, the response to the first signal comprises an RRC signaling for configuring a CORESET TCI-state.

In one embodiment, the response to the first signal comprises Downlink Control Information (DCI).

In one embodiment, the response to the first signal comprises a physical layer signaling.

In one embodiment, the response to the first signal is transmitted on a PDCCH.

In one embodiment, the response to the first signal comprises an Msg4.

In one embodiment, the response to the first signal comprises an MsgB.

In one embodiment, the response to the first signal comprises a Contention Resolution PDSCH.

In one embodiment, CRC of the response to the first signal is scrambled by a C-RNTI or a Modulation and Coding Scheme (MCS)-C-RNTI.

In one embodiment, CRC of the response to the first signal is scrambled by a TC-RNTI.

In one embodiment, CRC of the response to the first signal is scrambled by a C-RNTI.

In one embodiment, CRC of the response to the first signal is scrambled by a MsgB-RNTI.

In one embodiment, CRC of the response to the first signal is scrambled by a Random Access (RA)-RNTI.

In one embodiment, the first signal comprises a PUSCH bearing the first message, where a Hybrid Automatic Repeat reQuest (HARQ) process number of the PUSCH bearing the first message is a first HARQ process number; the response to the first signal is a PUSCH-scheduled DCI indicating the first HARQ process number and a toggle NDI field value.

In one embodiment, the second sub-signal comprises a PUSCH bearing the first message, where a Hybrid Automatic Repeat reQuest (HARQ) process number of the second sub-signal is a first HARQ process number; the response to the first signal is a PUSCH-scheduled DCI indicating the first HARQ process number and a toggle NDI field value.

In one embodiment, the second link failure is used to trigger generation of a second message.

In one embodiment, the second message is used to trigger the second signal.

In one embodiment, the second message comprises a MAC CE.

In one embodiment, the second message comprises a PUSCH MAC CE.

In one embodiment, the second message comprises a Beam Failure Recovery (BFR) MAC CE.

In one embodiment, the second message comprises a Truncated BFR MAC CE.

In one embodiment, the second message comprises the first field.

In one embodiment, a value of the first field in the second message is equal to 1.

In one embodiment, a value of the first field in the second message is equal to 0.

In one embodiment, only the second message of the first message and the second message comprises a second field.

In one embodiment, the second message comprises the second field.

In one embodiment, the second field comprises a positive integer number of bit(s).

In one embodiment, the second field in the second message is used to determine the second index.

In one embodiment, the second field in the second message is used to indicate the second index.

In one embodiment, the second field in the second message explicitly indicates the second index.

In one embodiment, the second field in the second message implicitly indicates the second index.

In one embodiment, the second link recovery procedure comprises: the first transceiver transmitting a second signal in a second radio resource group.

In one embodiment, the second link recovery procedure comprises: the second transceiver monitoring a second signal in a second radio resource group.

In one embodiment, the meaning of the action of monitoring whether a second link recovery procedure is started comprises: the second transceiver monitoring in the second radio resource set whether there is any radio signal being transmitted.

In one embodiment, the meaning of the action of monitoring whether a first link recovery procedure is started comprises: the second transceiver monitoring in the second radio resource group whether the second signal is transmitted.

In one embodiment, the second radio resource group is different from the first radio resource group.

In one embodiment, the first signal set corresponds to a first radio resource set, while the second signal set corresponds to a second radio resource set, the first radio resource group belonging to the first radio resource set, and the second radio resource group belonging to the second radio resource set; the first radio resource set and the second radio resource set are configured by a higher layer signaling.

In one embodiment, the first signal set corresponds to a first radio resource group, while the second signal set corresponds to a second radio resource group.

In one embodiment, the second radio resource group comprises a positive integer number of radio resource(s).

In one embodiment, the second signal comprises a Random Access Preamble.

In one embodiment, the second signal comprises a second characteristic sequence.

In one embodiment, the second characteristic sequence comprises one or more of a pseudo-random sequence, a Zadoff-Chu sequence or a low-Peak-to-Average Power Ratio (low-PAPR) sequence.

In one embodiment, the second characteristic sequence comprises a Cyclic Prefix (CP).

In one embodiment, the second signal comprises a scheduling request (SR).

In one embodiment, the second signal comprises a scheduling request triggered by the second message.

In one embodiment, the second signal bears a second message.

In one embodiment, the second signal comprises a scheduling request (SR) and a second message.

In one embodiment, the second radio resource group comprises at least the PUCCH resource of a PUCCH resource or a PUSCH resource.

In one embodiment, the second radio resource group comprises a PUCCH resource.

In one embodiment, a PUCCH resource comprised in the second radio resource group is used for a Link Recovery Request (LRR).

In one embodiment, a PUSCH resource comprised in the second radio resource group is used for bearing a second message.

In one embodiment, the second radio resource group comprises a PUCCH resource and a PUSCH resource.

In one embodiment, the second radio resource group is configured by a schedulingRequestlD-BFR-SCell-r16.

In one embodiment, the second radio resource group comprises at least a Physical Random Access CHannel (PRACH) resource out of the PRACH resource or a radio resource occupied by a PUSCH scheduled by a Random Access Response (RAR) UL grant.

In one embodiment, the second radio resource group comprises a PRACH resource.

In one embodiment, the second radio resource group comprises a PRACH resource and a radio resource occupied by a PUSCH scheduled by a RAR UL grant.

In one embodiment, the second radio resource group is configured by a higher layer parameter.

In one embodiment, the second radio resource group is configured by a PRACH-ResourceDedicatedBFR.

In one embodiment, the second radio resource group comprises a third radio resource block and a fourth radio resource block, and the second signal comprises a third sub-signal and a fourth sub-signal, where the third radio resource block comprises a radio resource occupied by the third sub-signal, while the fourth radio resource block comprises a radio resource occupied by the fourth sub-signal.

In one embodiment, the third radio resource block comprises a PUCCH resource.

In one embodiment, the third radio resource block comprises a PUCCH resource used for a Link Recovery Request (LRR).

In one embodiment, the fourth radio resource block comprises a PUSCH resource used for bearing a second message.

In one embodiment, the third radio resource block is configured by a schedulingRequestID-BFR-SCell-r16.

In one embodiment, the third radio resource block comprises a PRACH resource.

In one embodiment, the third radio resource block comprises a PRACH-ResourceDedicatedBFR.

In one embodiment, the fourth radio resource block comprises a PUSCH resource.

In one embodiment, the third sub-signal comprises a first characteristic sequence.

In one embodiment, the third sub-signal comprises a Random Access Preamble.

In one embodiment, the fourth sub-signal comprises a Medium Access Control layer Control Element (MAC CE).

In one embodiment, the fourth sub-signal comprises a Beam Failure Recovery (BFR) MAC CE.

In one embodiment, the fourth sub-signal comprises a Truncated BFR MAC CE.

In one embodiment, the fourth sub-signal bears a second message.

In one embodiment, the third sub-signal comprises an Msg1, while the fourth sub-signal comprises an Msg3 PUSCH.

In one embodiment, the third sub-signal comprises an Msg1, while the fourth sub-signal comprises a PUSCH scheduled by a RAR UL grant.

In one embodiment, the second signal comprises an MsgA, the third sub-signal comprises a random access preamble in the MsgA, while the fourth sub-signal comprises a PUSCH in the MsgA.

In one embodiment, the third sub-signal comprises a scheduling request (SR).

In one embodiment, the third sub-signal comprises a scheduling request triggered by the second message.

In one embodiment, the second link recovery procedure comprises: the first transceiver monitoring a response to the second signal in a fourth radio resource group; herein, the fourth radio resource group belongs to a second time window in time domain, where a start of the second time window is later than an end time of the second radio resource group.

In one embodiment, the second link recovery procedure comprises: the second transceiver transmitting a response to the second signal in a fourth radio resource group; herein, the fourth radio resource group belongs to a second time window in time domain, where a start of the second time window is later than an end time of the second radio resource group.

In one embodiment, the second time window comprises contiguous time-domain resources.

In one embodiment, a duration of the second time window is configured by a higher layer signaling.

In one embodiment, a duration of the second time window is configured by a BeamFailureRecoveryConfig IE.

In one embodiment, a duration of the second time window is configured by a beamFailureRecoveryTimer.

In one embodiment, a duration of the second time window is configured by a ra-ContentionResolutionTimer.

In one embodiment, a duration of the second time window is different from a duration of the first time window.

In one embodiment, a duration of the second time window is smaller than a duration of the first time window.

In one embodiment, a duration of the second time window and a duration of the first time window are configured respectively by two higher-layer parameters.

In one embodiment, the fourth radio resource group comprises a positive integer number of radio resource(s).

In one embodiment, the fourth radio resource group comprises a search space.

In one embodiment, the fourth radio resource group comprises a search space set.

In one embodiment, the fourth radio resource group comprises one or more Physical Downlink Control Channel (PDCCH) candidates.

In one embodiment, the fourth radio resource group comprises a COntrol REsource SET (CORESET).

In one embodiment, a search space set to which the fourth radio resource group belongs is identified by a recoverySearchSpaceId.

In one embodiment, an index of a search space set to which the fourth radio resource group belongs is equal to 0.

In one embodiment, a search space set to which the fourth radio resource group belongs includes a Type1-PDCCH Common search space (CSS) set.

In one embodiment, the fourth radio resource group belongs to a PDCCH Common search space (CSS) set.

In one embodiment, the fourth radio resource group is associated with the second index.

In one embodiment, the response to the second signal comprises a higher layer activation command for a TCI state.

In one embodiment, the response to the second signal comprises an activation command for a higher-layer parameter tci-StatesPDCCH-ToAddList and/or a higher-layer parameter tci-StatesPDCCH-ToReleaseList.

In one embodiment, the response to the second signal comprises a MAC CE used for indicating a PDCCH TCI.

In one embodiment, the response to the second signal comprises an RRC signaling for configuring a CORESET TCI-state.

In one embodiment, the response to the second signal comprises Downlink Control Information (DCI).

In one embodiment, the response to the second signal comprises a physical layer signaling.

In one embodiment, the response to the second signal is transmitted on a PDCCH.

In one embodiment, the response to the second signal comprises an Msg4.

In one embodiment, the response to the second signal comprises an MsgB.

In one embodiment, the response to the second signal comprises a Contention Resolution PDSCH.

In one embodiment, CRC of the response to the second signal is scrambled by a C-RNTI or a Modulation and Coding Scheme (MCS)-C-RNTI.

In one embodiment, CRC of the response to the second signal is scrambled by a TC-RNTI.

In one embodiment, CRC of the response to the second signal is scrambled by a C-RNTI.

In one embodiment, CRC of the response to the second signal is scrambled by a MsgB-RNTI.

In one embodiment, CRC of the response to the second signal is scrambled by a Random Access (RA)-RNTI.

In one embodiment, the second signal comprises a PUSCH bearing the second message, where a Hybrid Automatic Repeat reQuest (HARQ) process number of the PUSCH bearing the second message is a second HARQ process number; the response to the second signal is a PUSCH-scheduled DCI indicating the second HARQ process number and a toggle NDI field value.

In one embodiment, the fourth sub-signal comprises a PUSCH bearing the second message, where a Hybrid Automatic Repeat reQuest (HARQ) process number of the fourth sub-signal is a second HARQ process number; the response to the second signal is a PUSCH-scheduled DCI indicating the second HARQ process number and a toggle NDI field value.

In one embodiment, the sentence “monitoring a given signal” means: determining according to CRC whether the given signal is to be transmitted.

In one subembodiment, the given signal is the first signal.

In one subembodiment, the given signal is the second signal.

In one subembodiment, the given signal is the response to the first signal.

In one subembodiment, the given signal is the response to the second signal.

In one embodiment, the sentence “monitoring a given signal” means: being unsure of whether the given signal is to be transmitted before it is determined whether decoding is correct according to CRC.

In one subembodiment, the given signal is the first signal.

In one subembodiment, the given signal is the second signal.

In one subembodiment, the given signal is the response to the first signal.

In one subembodiment, the given signal is the response to the second signal.

In one embodiment, the sentence “monitoring a given signal” means: determining according to coherent detection whether the given signal is to be transmitted.

In one subembodiment, the given signal is the first signal.

In one subembodiment, the given signal is the second signal.

In one subembodiment, the given signal is the response to the first signal.

In one subembodiment, the given signal is the response to the second signal.

In one embodiment, the sentence “monitoring a given signal” means: being unsure of whether the given signal is to be transmitted before coherent detection.

In one subembodiment, the given signal is the first signal.

In one subembodiment, the given signal is the second signal.

In one subembodiment, the given signal is the response to the first signal.

In one subembodiment, the given signal is the response to the second signal.

In one embodiment, the sentence “monitoring a given signal” means: determining according to energy detection whether the given signal is to be transmitted.

In one subembodiment, the given signal is the first signal.

In one subembodiment, the given signal is the second signal.

In one subembodiment, the given signal is the response to the first signal.

In one subembodiment, the given signal is the response to the second signal.

In one embodiment, the sentence “monitoring a given signal” includes a meaning that: being unsure of whether the given signal is to be transmitted before energy detection.

In one subembodiment, the given signal is the first signal.

In one subembodiment, the given signal is the second signal.

In one subembodiment, the given signal is the response to the first signal.

In one subembodiment, the given signal is the response to the second signal.

In one embodiment, the first node determines whether the first link recovery procedure is successfully completed according to whether the response to the first signal is detected in the first time window.

In one embodiment, when the first node detects the response to the first signal in the first time window, the first link recovery procedure is successfully completed.

In one embodiment, when the first node does not detect the response to the first signal in the first time window, the first link recovery procedure is not successfully completed.

In one embodiment, the first link recovery procedure comprises a first random access procedure, the first random access procedure being a Contention-Free random access procedure, and the first random access procedure comprising transmitting a random access preamble, the first link recovery procedure being successfully completed comprises successfully receiving a response to the random access preamble in the first random access procedure.

In one subembodiment, the first link recovery procedure not being successfully completed comprises not successfully receiving a response to the random access preamble in the first random access procedure.

In one embodiment, the first link recovery procedure comprises a first random access procedure, the first random access procedure being a Contention-Free random access procedure, and the first random access procedure comprising transmitting a random access preamble, the first link recovery procedure being successfully completed comprises successfully receiving a RAR to the random access preamble.

In one subembodiment, the first link recovery procedure not being successfully completed comprises not successfully receiving a RAR to the random access preamble.

In one embodiment, the first link recovery procedure being successfully completed comprises successfully receiving a higher layer activation command for a TCI state, or an activation command of a higher layer parameter tci-StatesPDCCH-ToAddList and/or a higher layer parameter tci-StatesPDCCH-ToReleaseList.

In one subembodiment, the first link recovery procedure not being successfully completed comprises not successfully receiving a higher layer activation command for a TCI state, or an activation command of a higher layer parameter tci-StatesPDCCH-ToAddList and/or a higher layer parameter tci-StatesPDCCH-ToReleaseList.

In one embodiment, the first link recovery procedure comprises a first random access procedure, the first random access procedure being a Contention-based random access procedure, and the first link recovery procedure being successfully completed comprises successfully receiving an Msg4 in the first random access procedure.

In one subembodiment, the first link recovery procedure not being successfully completed comprises not successfully receiving an Msg4 in the first random access procedure.

In one embodiment, the first link recovery procedure comprises a first random access procedure, the first random access procedure being a Contention-based random access procedure, and the first link recovery procedure being successfully completed comprises successfully receiving an MsgB in the first random access procedure.

In one subembodiment, the first link recovery procedure not being successfully completed comprises not successfully receiving an MsgB in the first random access procedure.

In one embodiment, the first link recovery procedure comprises transmitting a first message, and the first link recovery procedure being successfully completed comprises successfully receiving a DCI, the DCI indicating a new transmission of a HARQ process used for transmitting the first message.

In one subembodiment, the first link recovery procedure not being successfully completed comprises not successfully receiving the DCI.

In one embodiment, the first node determines whether the second link recovery procedure is successfully completed according to whether the response to the second signal is detected in the second time window.

In one embodiment, when the first node detects the response to the second signal in the second time window, the second link recovery procedure is successfully completed.

In one embodiment, when the first node does not detect the response to the second signal in the second time window, the second link recovery procedure is not successfully completed.

In one embodiment, the second link recovery procedure comprises a second random access procedure, the second random access procedure being a Contention-Free random access procedure, and the second random access procedure comprising transmitting a random access preamble, the second link recovery procedure being successfully completed comprises successfully receiving a response to the random access preamble in the second random access procedure.

In one subembodiment, the second link recovery procedure not being successfully completed comprises not successfully receiving a response to the random access preamble in the second random access procedure.

In one embodiment, the second link recovery procedure comprises a second random access procedure, the second random access procedure being a Contention-Free random access procedure, and the second random access procedure comprising transmitting a random access preamble, the second link recovery procedure being successfully completed comprises successfully receiving a RAR to the random access preamble.

In one subembodiment, the second link recovery procedure not being successfully completed comprises not successfully receiving a RAR to the random access preamble.

In one embodiment, the second link recovery procedure being successfully completed comprises successfully receiving a higher layer activation command for a TCI state, or an activation command of a higher layer parameter tci-StatesPDCCH-ToAddList and/or a higher layer parameter tci-StatesPDCCH-ToReleaseList.

In one subembodiment, the second link recovery procedure not being successfully completed comprises not successfully receiving a higher layer activation command for a TCI state, or an activation command of a higher layer parameter tci-StatesPDCCH-ToAddList and/or a higher layer parameter tci-StatesPDCCH-ToReleaseList.

In one embodiment, the second link recovery procedure comprises a second random access procedure, the second random access procedure being a Contention-based random access procedure, and the second link recovery procedure being successfully completed comprises successfully receiving an Msg4 in the second random access procedure.

In one subembodiment, the second link recovery procedure not being successfully completed comprises not successfully receiving an Msg4 in the second random access procedure.

In one embodiment, the second link recovery procedure comprises a second random access procedure, the second random access procedure being a Contention-based random access procedure, and the second link recovery procedure being successfully completed comprises successfully receiving an MsgB in the second random access procedure.

In one subembodiment, the second link recovery procedure not being successfully completed comprises not successfully receiving an MsgB in the second random access procedure.

In one embodiment, the second link recovery procedure comprises transmitting a second message, and the second link recovery procedure being successfully completed comprises successfully receiving a DCI, the DCI indicating a new transmission of a HARQ process used for transmitting the second message.

In one subembodiment, the second link recovery procedure not being successfully completed comprises not successfully receiving the DCI.

In one embodiment, as a response to successfully completing the first link recovery procedure, the first counter is set to 0.

In one embodiment, as a response to successfully completing the second link recovery procedure, the second counter is set to 0.

In one embodiment, as a response to successfully completing the first link recovery procedure, the first counter and the second counter are both set to 0.

In one embodiment, the measurement of the first signal set comprises a channel measurement, and the measurement of the second signal set comprises a channel measurement.

In one embodiment, the measurement of the first signal set comprises an interference measurement, and the measurement of the second signal set comprises an interference measurement.

In one embodiment, the measurement of the first signal set comprises a channel measurement and an interference measurement, and the measurement of the second signal set comprises a channel measurement and an interference measurement.

In one embodiment, the phrase that a measurement of the first signal set is used to determine a first link failure comprises that: a measurement of the first signal set is used to determine a value of a first counter; the first counter being no smaller than the first value is used to determine the first link failure; the phrase of a measurement of the second signal set being used to determine a second link failure comprises: a measurement of the second signal set is used to determine a value of a second counter; the second counter being no smaller than the second value is used to determine the second link failure.

In one embodiment, the phrase that a measurement of the first signal set is used to determine a first link failure comprises that: the higher layer increments the value of a first counter by 1 for each reception of a said first-type indication, where the first counter being no smaller than a first value is used to determine the first link failure; the phrase of a measurement of the second signal set being used to determine a second link failure comprises: the higher layer increments the value of a second counter by 1 for each reception of a said second-type indication, where the second counter being no smaller than a second value is used to determine the second link failure.

In one embodiment, the phrase that a measurement of the first signal set is used to determine a first link failure comprises that: as a response to a radio link quality determined by a measurement of the first signal set being worse than a first threshold, reporting to higher layers a first-type indication used for updating a first counter; the phrase of a measurement of the second signal set being used to determine a second link failure comprises: as a response to a radio link quality determined by a measurement of the second signal set being worse than a second threshold, reporting to higher layers a second-type indication used for updating a second counter.

In one embodiment, the phrase that “a radio link quality determined by a measurement of the first signal set being worse than a first threshold” means that: the radio link quality determined by the measurement of the first signal set is smaller than the first threshold; the phrase that “a radio link quality determined by a measurement of the second signal set being worse than a second threshold” means that: the radio link quality determined by the measurement of the second signal set is smaller than the second threshold.

In one subembodiment, the radio link quality is an RSRP.

In one subembodiment, the radio link quality is a L1-RSRP.

In one subembodiment, the radio link quality is a SINR.

In one subembodiment, the radio link quality is a L1-SINR.

In one embodiment, the phrase that “a radio link quality determined by a measurement of the first signal set being worse than a first threshold” means that: the radio link quality determined by the measurement of the first signal set is larger than the first threshold; the phrase that “a radio link quality determined by a measurement of the second signal set being worse than a second threshold” means that: the radio link quality determined by the measurement of the second signal set is larger than the second threshold.

In one subembodiment, the radio link quality is a BLER.

In one subembodiment, the radio link quality is a hypothetical BLER.

In one subembodiment, the radio link quality is obtained based on RSRP by looking up in a table.

In one subembodiment, the radio link quality is obtained based on L1-RSRP by looking up in a table.

In one subembodiment, the radio link quality is obtained based on SINR by looking up in a table.

In one subembodiment, the radio link quality is obtained based on L1-SINR by looking up in a table.

In one subembodiment, the radio link quality is obtained according to hypothetical PDCCH transmission parameters.

In one embodiment, the phrase that “a received quality of each reference signal in the first signal set being lower than a first threshold” means that: the received quality of each reference signal in the first signal set is smaller than the first threshold; the phrase that “a received quality of each reference signal in the second signal set being lower than a second threshold” means that: the received quality of each reference signal in the second signal set is smaller than the second threshold.

In one subembodiment, the received quality is an RSRP.

In one subembodiment, the received quality is a L1-RSRP.

In one subembodiment, the received quality is a SINR.

In one subembodiment, the received quality is a L1-SINR.

In one embodiment, the phrase that “a received quality of each reference signal in the first signal set being lower than a first threshold” means that: the received quality of each reference signal in the first signal set is greater than the first threshold; the phrase that “a received quality of each reference signal in the second signal set being lower than a second threshold” means that: the received quality of each reference signal in the second signal set is greater than the second threshold.

In one subembodiment, the received quality is a BLER.

In one subembodiment, the received quality is a hypothetical BLER.

In one subembodiment, the received quality is obtained by looking up in a table of RSRP.

In one subembodiment, the received quality is obtained by looking up in a table of L1-RSRP.

In one subembodiment, the received quality is obtained by looking up in a table of SINR.

In one subembodiment, the received quality is obtained by looking up in a table of L1-SINR.

In one subembodiment, the received quality is obtained according to hypothetical PDCCH transmission parameters.

In one embodiment, a said first-type indication is used for indicating a first-type signal and a first-type received quality; the first-type received quality is determined by a measurement of the first-type signal, and the first-type received quality is no smaller than a third threshold; the first-type signal is one of M1 reference signals, M1 being a positive integer greater than 1.

In one embodiment, the first receiver receives the M1 reference signals.

In one embodiment, any of the M1 reference signals comprises a CSI-RS or an SSB.

In one embodiment, the M1 reference signals are configured by a higher layer parameter.

In one embodiment, a higher layer parameter for configuring the M1 reference signals comprises all or partial information in a candidateBeamRSList field of a BeamFailureRecoveryConfig IE.

In one embodiment, the M1 reference signals are configured by an IE.

In one embodiment, the M1 reference signals are configured by two IEs.

In one embodiment, names of an IE used for configuring the M1 reference signals include BeamFailureRecovery.

In one embodiment, names of an IE used for configuring the M1 reference signals include BeamFailure.

In one embodiment, the first-type received quality is an RSRP.

In one embodiment, the first-type received quality is a L1-RSRP.

In one embodiment, the first-type received quality is a SINR.

In one embodiment, the first-type received quality is a L1-SINR.

In one embodiment, the third threshold is a real number.

In one embodiment, the third threshold is a non-negative real number.

In one embodiment, the third threshold is a non-negative real number no greater than 1.

In one embodiment, the third threshold is Q_{in_LR}.

In one embodiment, the definition of the Q_{in_LR} can be found in 3GPP TS38.133.

In one embodiment, the third threshold is configured by a higher layer parameter rsrp-ThresholdSSB.

In one embodiment, a said second-type indication is used for indicating a second-type signal and a second-type received quality; the second-type received quality is determined by a measurement of the second-type signal, and the second-type received quality is no smaller than a fourth threshold.

In one embodiment, the second-type signal is one of M1 reference signals, M1 being a positive integer greater than 1.

In one embodiment, the second-type signal is one of M2 reference signals, M2 being a positive integer greater than 1.

In one embodiment, the first receiver receives the M2 reference signals.

In one embodiment, any of the M2 reference signals comprises a CSI-RS or an SSB.

In one embodiment, the M2 reference signals are configured by a higher layer parameter.

In one embodiment, a higher layer parameter for configuring the M2 reference signals comprises all or partial information in a candidateBeamRSList field of a BeamFailureRecoveryConfig IE.

In one embodiment, names of an IE used for configuring the M2 reference signals include BeamFailureRecovery.

In one embodiment, names of an IE used for configuring the M2 reference signals include BeamFailure.

In one embodiment, the M1 reference signals and the M2 reference signals are configured by different IEs.

In one embodiment, the M1 reference signals and the M2 reference signals are configured by a same IE.

In one embodiment, the M1 reference signals correspond to the first index, while the M2 reference signals correspond to the second index.

In one embodiment, the M1 reference signals correspond to the first signal set, while the M2 reference signals correspond to the second signal set.

In one embodiment, the second-type received quality is an RSRP.

In one embodiment, the second-type received quality is a L1-RSRP.

In one embodiment, the second-type received quality is a SINR.

In one embodiment, the second-type received quality is a L1-SINR.

In one embodiment, the fourth threshold is a real number.

In one embodiment, the fourth threshold is a non-negative real number.

In one embodiment, the fourth threshold is a non-negative real number no greater than 1.

In one embodiment, the fourth threshold is Q_{in_LR}.

In one embodiment, the fourth threshold is configured by a higher layer parameter rsrp-ThresholdSSB.

In one embodiment, the fourth threshold and the third threshold are identical and configured by a same higher-layer parameter.

In one embodiment, the fourth threshold and the third threshold are independently configured.

In one embodiment, the first link recovery procedure comprises: a physical layer of the first node receiving a first information block from a higher layer of the first node; herein, the first information block is used to indicate a first reference signal; the first signal is used to indicate the first reference signal, or the first radio resource group is used to indicate the first reference signal.

In one embodiment, the second sub-signal is used to indicate the first reference signal.

In one embodiment, the first radio resource group is a radio resource group in the first radio resource set that corresponds to the first reference signal.

In one embodiment, the first reference signal is used to determine a spatial-domain relation of the third radio resource group.

In one embodiment, the second link recovery procedure comprises: a physical layer of the first node receiving a second information block from a higher layer of the first node; herein, the second information block is used to indicate a second reference signal; the second signal is used to indicate the second reference signal, or the second radio resource group is used to indicate the second reference signal.

In one embodiment, the fourth sub-signal is used to indicate the second reference signal.

In one embodiment, the second radio resource group is a radio resource group in the second radio resource set that corresponds to the second reference signal.

In one embodiment, the second reference signal is used to determine a spatial-domain relation of the fourth radio resource group.

In one embodiment, the spatial-domain relation comprises a Transmission Configuration Indicator (TCI) state.

In one embodiment, the spatial-domain relation comprises a Quasi co-location (QCL) parameter.

In one embodiment, the spatial-domain relation comprises a Spatial domain filter.

In one embodiment, the spatial-domain relation comprises a Spatial domain transmission filter.

In one embodiment, the spatial-domain relation comprises a Spatial domain reception filter.

In one embodiment, the spatial-domain relation comprises Spatial Tx parameters.

In one embodiment, the spatial-domain relation comprises Spatial Rx parameters.

In one embodiment, the Spatial Tx parameters include one or more of a transmission antenna port, a transmission antenna port group, a transmission analog beamforming matrix, a transmission analog beamforming vector, a transmission beamforming matrix, a transmission beamforming vector or a spatial domain transmission filter.

In one embodiment, the Spatial Rx parameters include one or more of a receiving beam, a reception analog beamforming matrix, a reception analog beamforming vector, a reception beamforming matrix, a reception beamforming vector or a spatial domain reception filter.

In one embodiment, a given reference signal is used to determine a spatial-domain relation of a given radio resource group.

In one subembodiment, the given reference signal is the first reference signal, and the given radio resource group is the third radio resource group.

In one subembodiment, the given reference signal is the second reference signal, and the given radio resource group is the fourth radio resource group.

In one subembodiment, a TCI state of the given reference signal is used to determine a spatial domain relation of the given radio resource group.

In one subembodiment, the spatial domain relation comprises a TCI state, where a TCI state of the given reference signal is identical to a TCI state of the given radio resource group.

In one subembodiment, a QCL parameter of the given reference signal is used to determine a spatial domain relation of the given radio resource group.

In one subembodiment, the spatial domain relation comprises a QCL parameter, where a QCL parameter of the given reference signal is identical to a QCL parameter of the given radio resource group.

In one subembodiment, a spatial domain filter of the given reference signal is used to determine a spatial domain relation of the given radio resource group.

In one subembodiment, the spatial domain relation comprises a spatial domain filter, where a spatial domain filter of the given reference signal is identical to a spatial domain filter of the given radio resource group.

In one subembodiment, the spatial domain relation comprises a spatial domain transmission filter, and the given reference signal is an uplink signal, where a spatial domain transmission filter of the given reference signal is identical to a spatial domain transmission filter of the given radio resource group.

In one subembodiment, the spatial domain relation comprises a spatial domain transmission filter, and the given reference signal is a downlink signal, where a spatial domain reception filter of the given reference signal is identical to a spatial domain transmission filter of the given radio resource group.

In one subembodiment, the spatial domain relation comprises a spatial domain reception filter, and the given reference signal is an uplink signal, where a spatial domain reception filter of the given reference signal is identical to a spatial domain reception filter of the given radio resource group.

In one subembodiment, the spatial domain relation comprises a spatial domain reception filter, and the given reference signal is a downlink signal, where a spatial domain transmission filter of the given reference signal is identical to a spatial domain reception filter of the given radio resource group.

In one subembodiment, a spatial parameter of the given reference signal is used to determine a spatial domain relation of the given radio resource group.

In one subembodiment, the spatial domain relation comprises spatial transmission parameters, where spatial parameters of the given reference signal are identical to spatial transmission parameters of the given radio resource group.

In one subembodiment, the spatial domain relation comprises spatial transmission parameters, and the given reference signal is an uplink signal, where spatial transmission parameters of the given reference signal are identical to spatial transmission parameters of the given radio resource group.

In one subembodiment, the spatial domain relation comprises spatial transmission parameters, and the given reference signal is a downlink signal, where spatial reception parameters of the given reference signal are identical to spatial transmission parameters of the given radio resource group.

In one subembodiment, the spatial domain relation comprises spatial reception parameters, where spatial parameters of the given reference signal are identical to spatial reception parameters of the given radio resource group.

In one subembodiment, the spatial domain relation comprises spatial reception parameters, and the given reference signal is an uplink signal, where spatial reception parameters of the given reference signal are identical to spatial reception parameters of the given radio resource group.

In one subembodiment, the spatial domain relation comprises spatial reception parameters, and the given reference signal is a downlink signal, where spatial transmission parameters of the given reference signal are identical to spatial reception parameters of the given radio resource group.

In one embodiment, what a first action is before a second action means is that the first action is earlier than the second action in time.

In one embodiment, what a first action is after a second action means is that the first action is later than the second action in time.

### Embodiment 6

Embodiment 6 illustrates a schematic diagram of determining a first link failure and a second link failure according to one embodiment of the present application; as shown in FIG. 6.

In Embodiment 6, the phrase that a measurement of the first signal set is used to determine a first link failure comprises: as a response to a received quality of each reference signal in the first signal set being lower than a first threshold, reporting to higher layers a first-type indication used for updating a first counter; the phrase of a measurement of the second signal set being used to determine a second link failure comprises: as a response to a received quality of each reference signal in the second signal set being lower than a second threshold, reporting to higher layers a second-type indication used for updating a second counter.

In one embodiment, the specific definition of the hypothetical PDCCH transmission parameters can be found in 3GPP TS38.133.

In one embodiment, when the first counter is no smaller than a first value, determining the first link failure.

In one embodiment, when the second counter is no smaller than a second value, determining the second link failure.

In one embodiment, the action of updating includes incrementing a current value by 1.

In one embodiment, when the first counter is no greater than a first value, determining the first link failure.

In one embodiment, when the second counter is no greater than a second value, determining the second link failure.

In one embodiment, the first threshold and the second threshold are fixed.

In one embodiment, the first threshold and the second threshold are independently configured by higher-layer signalings.

In one embodiment, the second threshold and the first threshold are respectively configured by two higher-layer parameters.

In one embodiment, the second threshold and the first threshold are configured by a same higher-layer parameter.

In one embodiment, the first value and the second value are fixed.

In one embodiment, the first value is equal to the second value.

In one embodiment, the first value and the second value are independently configured by higher-layer signalings.

In one embodiment, the second value and the first value are respectively configured by two higher-layer parameters.

In one embodiment, the second value and the first value are configured by a same higher-layer parameter.

In one embodiment, the first threshold is a real number.

In one embodiment, the first threshold is a non-negative real number.

In one embodiment, the first threshold is a non-negative real number no greater than 1.

In one embodiment, the first threshold is one of Q_{out_L}, Q_{out_LR_SSB} or Q_{out_LR_CSI-RS}.

In one embodiment, for definitions of the Q_{out_LR}, Q_{out_LR_SSB} and Q_{out_LR_CSI-RS}, refer to 3GPP TS38.133.

In one embodiment, the first threshold is configured by a higher layer parameter rlmInSyncOutOfSyncThreshold.

In one embodiment, the second threshold is a real number.

In one embodiment, the second threshold is a non-negative real number.

In one embodiment, the second threshold is a non-negative real number no greater than 1.

In one embodiment, the second threshold is one of Q_{Out_L}, Q_{out_LR_SSB} or Q_{Out_LR_CSI-RS}.

In one embodiment, the second threshold is configured by a higher layer parameter rlmInSyncOutOfSyncThreshold.

In one embodiment, a said first-type indication is a beam failure instance indication.

In one embodiment, a said first-type indication is a radio link quality indication.

In one embodiment, a said first-type indication is a received quality indication.

In one embodiment, a said second-type indication is a beam failure instance indication.

In one embodiment, a said second-type indication is a radio link quality indication.

In one embodiment, a said second-type indication is a received quality indication.

In one embodiment, the first-type indication corresponds to the first counter, while the second-type indication corresponds to the second counter.

In one embodiment, the first-type indication corresponds to the first index, while the second-type indication corresponds to the second index.

In one embodiment, the first-type indication corresponds to the first signal set, while the second-type indication corresponds to the second signal set.

In one embodiment, the first counter is a BFI_COUNTER.

In one embodiment, an initial value of the first counter is 0.

In one embodiment, a value of the first counter is a non-negative integer.

In one embodiment, the first value is a positive integer.

In one embodiment, the first value is beamFailureInstanceMaxCount.

In one embodiment, the first value is configured by a higher layer parameter.

In one embodiment, a higher layer parameter for configuring the first value comprises all or partial information in a beamFailureInstanceMaxCount field in a RadioLinkMonitoringConfig IE.

In one embodiment, the higher layer starts or restarts a first timer for each reception of a said first-type indication, and increments the first counter by 1.

In one embodiment, the first timer is a beamFailureDetectionTimer.

In one embodiment, when the first timer expires, the first counter is cleared to zero.

In one embodiment, an initial value of the first timer is a positive integer.

In one embodiment, an initial value of the first timer is a positive real number.

In one embodiment, an initial value of the first timer is configured by a higher-layer parameter beamFailureDetectionTimer.

In one embodiment, an initial value of the first timer is configured by an IE.

In one embodiment, names of an IE for configuring an initial value of the first timer include RadioLinkMonitoring.

In one embodiment, the second counter is a BFI_COUNTER.

In one embodiment, an initial value of the second counter is 0.

In one embodiment, a value of the second counter is a non-negative integer.

In one embodiment, the second value is a positive integer.

In one embodiment, the second value is beamFailureInstanceMaxCount.

In one embodiment, the second value is configured by a higher layer parameter.

In one embodiment, a higher layer parameter for configuring the second value comprises all or partial information in a beamFailureInstanceMaxCount field in a RadioLinkMonitoringConfig IE.

In one embodiment, the higher layer starts or restarts a second timer for each reception of a said second-type indication, and increments the second counter by 1.

In one embodiment, the second timer is a beamFailureDetectionTimer.

In one embodiment, when the second timer expires, the second counter is cleared to zero.

In one embodiment, an initial value of the second timer is a positive integer.

In one embodiment, an initial value of the second timer is a positive real number.

In one embodiment, an initial value of the second timer is configured by a higher-layer parameter beamFailureDetectionTimer.

In one embodiment, an initial value of the second timer is configured by an IE.

In one embodiment, names of an IE for configuring an initial value of the second timer include RadioLinkMonitoring.

### Embodiment 7

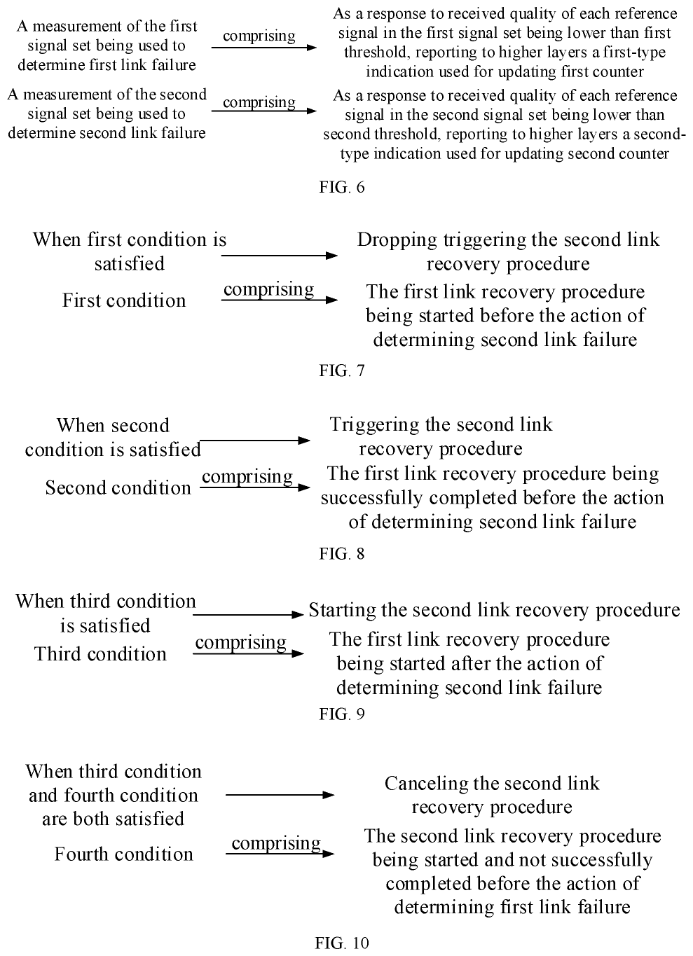

Embodiment 7 illustrates a schematic diagram of whether a second link recovery procedure is triggered according to one embodiment of the present application; as shown in FIG. 7.

In Embodiment 7, when a first condition is satisfied, the first transceiver drops triggering the second link recovery procedure; where the first condition comprises that the first link recovery procedure is started before the action of determining a second link failure.

In one embodiment, the first parameter is used to determine whether the first condition is satisfied.

In one embodiment, at least the first parameter of the first parameter or the second parameter is used to determine whether the first condition is satisfied.

In one embodiment, the first condition comprises: the first link recovery procedure being started before the action of determining a second link failure, and the first link recovery procedure not being successfully completed before the action of determining a second link failure.

In one embodiment, the first condition comprises more than one sub-condition; a sub-condition in the first condition comprises that: the first link recovery procedure is started before the action of determining a second link failure.

In one embodiment, the first condition comprises more than one sub-condition; a sub-condition in the first condition comprises that: the second link recovery procedure does not comprise a random access procedure.

In one embodiment, the first condition comprises more than one sub-condition; when any sub-condition in the first condition is satisfied, the first condition is satisfied.

In one embodiment, the first condition comprises more than one sub-condition; when each sub-condition in the first condition is satisfied, the first condition is satisfied.

In one embodiment, the phrase of dropping triggering the second link recovery procedure comprises: keeping the value of the second counter unchanged.

### Embodiment 8

Embodiment 8 illustrates a schematic diagram of whether a second link recovery procedure is triggered according to another embodiment of the present application; as shown in FIG. 8.

In Embodiment 8, when a second condition is satisfied, as a response to the action of determining a second link failure, the first transceiver triggers the second link recovery procedure; where the second condition comprises that the first link recovery procedure is successfully completed before the action of determining a second link failure.

In one embodiment, the first parameter is used to determine whether the second condition is satisfied.

In one embodiment, at least the first parameter of the first parameter or the second parameter is used to determine whether the second condition is satisfied.

In one embodiment, the second condition comprises: the first link recovery procedure being started before the action of determining a second link failure, and the first link recovery procedure being successfully completed before the action of determining a second link failure.

In one embodiment, the second condition comprises more than one sub-condition; a sub-condition in the second condition comprises that: the first link recovery procedure is successfully completed before the action of determining a second link failure.

In one embodiment, the second condition comprises more than one sub-condition; a sub-condition in the second condition comprises that: the second link recovery procedure comprises a random access procedure.

In one embodiment, the second condition comprises more than one sub-condition; when any sub-condition in the second condition is satisfied, the second condition is satisfied.

In one embodiment, the second condition comprises more than one sub-condition; when each sub-condition in the second condition is satisfied, the second condition is satisfied.

### Embodiment 9

Embodiment 9 illustrates a schematic diagram of whether a second link recovery procedure is triggered according to another embodiment of the present application; as shown in FIG. 9.

In Embodiment 9, when a third condition is satisfied, the first transceiver starts the second link recovery procedure; where the third condition comprises that the first link recovery procedure is started after the action of determining a second link failure.

In one embodiment, the first parameter is used to determine whether the third condition is satisfied.

In one embodiment, at least the first parameter of the first parameter or the second parameter is used to determine whether the third condition is satisfied.

In one embodiment, the third condition comprises more than one sub-condition; a sub-condition in the third condition comprises that: the first link recovery procedure is started after the action of determining a second link failure.

In one embodiment, the third condition comprises more than one sub-condition; a sub-condition in the third condition comprises that: the second link recovery procedure comprises a random access procedure.

In one embodiment, the third condition comprises more than one sub-condition; when any sub-condition in the third condition is satisfied, the third condition is satisfied.

In one embodiment, the third condition comprises more than one sub-condition; when each sub-condition in the third condition is satisfied, the third condition is satisfied.

In one embodiment, the third condition comprises: the action of determining a first link failure being after the action of determining a second link failure, and the first link recovery procedure being started after the action of determining a second link failure.

In one embodiment, the second link recovery procedure is started; the third condition comprises: the action of determining a first link failure being after the action of starting the second link recovery procedure, and the first link recovery procedure being started after the action of determining a second link failure.

In one embodiment, the second link recovery procedure is started; the third condition comprises: the first link recovery procedure being started after the action of starting the second link recovery procedure, and the first link recovery procedure being started after the action of determining a second link failure.

### Embodiment 10

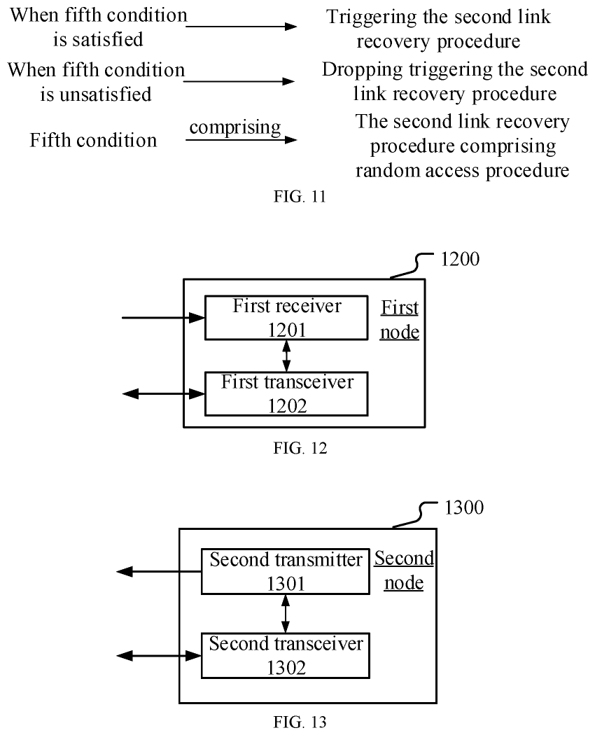

Embodiment 10 illustrates a schematic diagram of whether a second link recovery procedure is triggered according to another embodiment of the present application; as shown in FIG. 10.

In Embodiment 10, when the third condition and a fourth condition are both satisfied, as a response to triggering a first link recovery procedure, the first transceiver cancels the second link recovery procedure; where the fourth condition comprises that the second link recovery procedure is started and not successfully completed before the action of determining a first link failure.

In one embodiment, the first parameter is used to determine whether the fourth condition is satisfied.

In one embodiment, at least the first parameter of the first parameter or the second parameter is used to determine whether the fourth condition is satisfied.

In one embodiment, the fourth condition comprises more than one sub-condition; a sub-condition in the fourth condition comprises that: the second link recovery procedure is started and not successfully completed before the action of determining a first link failure.

In one embodiment, the fourth condition comprises more than one sub-condition; a sub-condition in the fourth condition comprises that: the second link recovery procedure comprises a random access procedure.

In one embodiment, the fourth condition comprises more than one sub-condition; when any sub-condition in the fourth condition is satisfied, the fourth condition is satisfied.

In one embodiment, the fourth condition comprises more than one sub-condition; when each sub-condition in the fourth condition is satisfied, the fourth condition is satisfied.

In one embodiment, when the second link recovery procedure is started and not successfully completed before the action of starting the first link recovery procedure, cancelling the second link recovery procedure.

In one embodiment, the second link recovery procedure is started and not successfully completed before the action of determining a first link failure, the second link recovery procedure comprising triggering a BFR; as a response to triggering a first link recovery procedure, cancelling the BFR triggered in the second link recovery procedure.

### Embodiment 11

Embodiment 11 illustrates a schematic diagram of whether a second link recovery procedure is triggered according to another embodiment of the present application; as shown in FIG. 11.

In Embodiment 11, when a fifth condition is satisfied, as a response to the action of determining a second link failure, the first transceiver triggers the second link recovery procedure; when the fifth condition is unsatisfied, the first transceiver drops triggering a second link recovery procedure; where the fifth condition comprises that the second link recovery procedure comprises a random access procedure.

In one embodiment, the second parameter is used to determine whether the fifth condition is satisfied.

In one embodiment, the second link recovery procedure comprises a first random access procedure, while the first link recovery procedure is started and not successfully completed before the action of determining a second link failure, the first link recovery procedure comprising triggering a BFR; as a response to triggering a second link recovery procedure, cancelling the BFR triggered in the first link recovery procedure.

In one embodiment, the second link recovery procedure comprises a first random access procedure, while the first link recovery procedure is started and not successfully completed before the action of determining a second link failure, the first link recovery procedure comprising triggering a Scheduling Request (SR); as a response to triggering a second link recovery procedure, cancelling the SR triggered in the first link recovery procedure.

In one embodiment, the second link recovery procedure comprises a first random access procedure, while the first link recovery procedure is started and not successfully completed before the action of determining a second link failure, the first link recovery procedure comprising generating a BFR MAC CE; as a response to triggering a second link recovery procedure, cancelling the BFR MAC CE generated in the first link recovery procedure.

In one embodiment, the second link recovery procedure comprises a first random access procedure, while the first link recovery procedure is started and not successfully completed before the action of determining a second link failure, the first link recovery procedure comprising generating a Truncated BFR MAC CE; as a response to triggering a second link recovery procedure, cancelling the Truncated BFR MAC CE generated in the first link recovery procedure.

### Embodiment 12

Embodiment 12 illustrates a structure block diagram of a processing device used in a first node according to one embodiment of the present application; as shown in FIG. 12. In FIG. 12, a processing device 1200 in a first node is comprised of a first receiver 1201 and a first transceiver 1202.

In one embodiment, the first node is a UE.

In one embodiment, the first node is a relay node.

In one embodiment, the first receiver 1201 comprises at least one of the antenna 452, the receiver 454, the receiving processor 456, the multi-antenna receiving processor 458, the controller/processor 459, the memory 460 or the data source 467 in Embodiment 4.

In one embodiment, the first transceiver 1202 comprises at least one of the antenna 452, the transmitter/receiver 454, the transmitting processor 468, the multi-antenna transmitting processor 457, the receiving processor 456, the multi-antenna receiving processor 458, the controller/processor 459, the memory 460 or the data source 467 in Embodiment 4.

The first receiver 1201: receives a first signal set and a second signal set; a measurement of the first signal set being used to determine a first link failure; and a measurement of the second signal set being used to determine a second link failure; and

The first transceiver 1202: as a response to the action of determining a first link failure, starts a first link recovery procedure; and determines according to at least one of a first parameter or a second parameter whether to trigger a second link recovery procedure as a response to the action of determining a second link failure;

In Embodiment 12, each of the first signal set and the second signal set respectively comprises at least one reference signal associated with a first cell, and there exists at least one reference signal that only belongs to one of the first signal set or the second signal set; the first parameter is a time of the first link recovery procedure relative to the action of determining a second link failure, and the second parameter is whether the second link recovery procedure comprises a random access procedure.

In one embodiment, the phrase that a measurement of the first signal set is used to determine a first link failure comprises that: as a response to a received quality of each reference signal in the first signal set being lower than a first threshold, reporting to higher layers a first-type indication used for updating a first counter; the phrase of a measurement of the second signal set being used to determine a second link failure comprises: as a response to a received quality of each reference signal in the second signal set being lower than a second threshold, reporting to higher layers a second-type indication used for updating a second counter.

In one embodiment, when a first condition is satisfied, the first transceiver 1202 drops triggering the second link recovery procedure; where the first condition comprises that the first link recovery procedure is started before the action of determining a second link failure.

In one embodiment, when a second condition is satisfied, as a response to the action of determining a second link failure, the first transceiver 1202 triggers the second link recovery procedure; where the second condition comprises that the first link recovery procedure is successfully completed before the action of determining a second link failure.

In one embodiment, when a third condition is satisfied, the first transceiver 1202 starts the second link recovery procedure; where the third condition comprises that the first link recovery procedure is started after the action of determining a second link failure.

In one embodiment, when the third condition and a fourth condition are both satisfied, as a response to triggering a first link recovery procedure, the first transceiver 1202 cancels the second link recovery procedure; where the fourth condition comprises that the second link recovery procedure is started and not successfully completed before the action of determining a first link failure.

In one embodiment, when a fifth condition is satisfied, as a response to the action of determining a second link failure, the first transceiver 1202 triggers the second link recovery procedure; when the fifth condition is unsatisfied, the first transceiver drops triggering a second link recovery procedure; where the fifth condition comprises that the second link recovery procedure comprises a random access procedure.

### Embodiment 13

Embodiment 13 illustrates a structure block diagram of a processing device used in a second node according to one embodiment of the present application; as shown in FIG. 13. In FIG. 13, a processing device 1300 in a second node is comprised of a second transmitter 1301 and a second transceiver 1302.

In one embodiment, the second node is a base station.

In one embodiment, the second node is a UE.

In one embodiment, the second node is a relay node.

In one embodiment, the second transmitter 1301 comprises at least one of the antenna 420, the transmitter 418, the transmitting processor 416, the multi-antenna transmitting processor 471, the controller/processor 475 or the memory 476 in Embodiment 4.

In one embodiment, the second transceiver 1302 comprises at least one of the antenna 420, the transmitter/receiver 418, the receiving processor 470, the multi-antenna receiving processor 472, the transmitting processor 416, the multi-antenna transmitting processor 471, the controller/processor 475 or the memory 476 in Embodiment 4.

The second transmitter 1301 transmits a first signal set and a second signal set; and

the second transceiver 1302 monitors whether a first link recovery procedure is started.

In Embodiment 13, when a measurement of the first signal set is used to determine a first link failure, the first link recovery procedure is started; when a measurement of the second signal set is used to determine a second link failure, at least one of a first parameter or a second parameter is used to determine whether a second link recovery procedure is triggered; each of the first signal set and the second signal set respectively comprises at least one reference signal associated with a first cell, and there exists at least one reference signal that only belongs to one of the first signal set or the second signal set; the first parameter is a time of the first link recovery procedure relative to the action of determining a second link failure, and the second parameter is whether the second link recovery procedure comprises a random access procedure.

In one embodiment, the second transceiver 1302 monitors whether the second link recovery procedure is started.

In one embodiment, when a first condition is satisfied, triggering of the second link recovery procedure is dropped; where the first condition comprises that the first link recovery procedure is started before the action of determining a second link failure.

In one embodiment, when a second condition is satisfied, as a response to the action of determining a second link failure, the second link recovery procedure is triggered; where the second condition comprises that the first link recovery procedure is successfully completed before the action of determining a second link failure.

In one embodiment, when a third condition is satisfied, the second link recovery procedure is triggered; where the third condition comprises that the first link recovery procedure is started after the action of determining a second link failure.

In one embodiment, when the third condition and a fourth condition are both satisfied, as a response to the first link recovery procedure being triggered, the second link recovery procedure is canceled; where the fourth condition comprises that the second link recovery procedure is started and not successfully completed before the action of determining a first link failure.

In one embodiment, when a fifth condition is satisfied, as a response to the action of determining a second link failure, the second link recovery procedure is triggered; when the fifth condition is unsatisfied, triggering of the second link recovery procedure is dropped; where the fifth condition comprises that the second link recovery procedure comprises a random access procedure.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The UE and terminal in the present application include but are not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, wireless sensor, network cards, terminals for Internet of Things (IOT), RFID terminals, NB-IOT terminals, Machine Type Communication (MTC) terminals, enhanced MTC (eMTC) terminals, data cards, low-cost mobile phones, low-cost tablet computers, etc. The base station or system device in the present application includes but is not limited to macro-cellular base stations, micro-cellular base stations, home base stations, relay base station, gNB (NR node B), Transmitter Receiver Point (TRP), and other radio communication equipment.

The above are merely the preferred embodiments of the present application and are not intended to limit the scope of protection of the present application. Any modification, equivalent substitute and improvement made within the spirit and principle of the present application are intended to be included within the scope of protection of the present application.

What is claimed is:

1. A first node for wireless communications, comprising:
a first receiver, receiving a first signal set and a second signal set; a measurement of the first signal set being used to determine a first link failure; and a measurement of the second signal set being used to determine a second link failure; and
a first transceiver, as a response to the action of determining a first link failure, starting a first link recovery procedure; and determining according to at least one of a first parameter or a second parameter whether to trigger a second link recovery procedure as a response to the action of determining a second link failure;
wherein each of the first signal set and the second signal set respectively comprises at least one reference signal associated with a first cell, and there exists at least one reference signal that only belongs to one of the first signal set or the second signal set; the first parameter is a time of the first link recovery procedure relative to the action of determining a second link failure, and the second parameter is whether the second link recovery procedure comprises a random access procedure.

2. The first node according to claim 1, wherein the phrase of a measurement of the first signal set being used to determine a first link failure comprises: as a response to a received quality of each reference signal in the first signal set being lower than a first threshold, reporting to higher layers a first-type indication used for updating a first counter; the phrase of a measurement of the second signal set being used to determine a second link failure comprises: as a response to a received quality of each reference signal in the second signal set being lower than a second threshold, reporting to higher layers a second-type indication used for updating a second counter.

3. The first node according to claim 1, wherein when a first condition is satisfied, the first transceiver drops triggering the second link recovery procedure; where the first condition comprises that the first link recovery procedure is started before the action of determining a second link failure; or, the first condition comprises that the first link recovery procedure is started before the action of determining a second link failure, and that the first link recovery procedure is not successfully completed before the action of determining a second link failure.

4. The first node according to claim 1, wherein when a second condition is satisfied, as a response to the action of determining a second link failure, the first transceiver triggers the second link recovery procedure; where the second condition comprises that the first link recovery procedure is successfully completed before the action of determining a second link failure.

5. The first node according to claim 1, wherein when a third condition is satisfied, the first transceiver starts the second link recovery procedure; where the third condition comprises that the first link recovery procedure is started after the action of determining a second link failure;
or, when the third condition is satisfied, the first transceiver starts the second link recovery procedure; where the third condition comprises that the first link recovery procedure is started after the action of determining a second link failure; when the third condition and a fourth condition are both satisfied, as a response to triggering a first link recovery procedure, the first transceiver terminates the second link recovery procedure; where the fourth condition comprises that the second link recovery procedure is started and not successfully completed before the action of determining a first link failure.

6. The first node according to claim 1, wherein when a fifth condition is satisfied, as a response to the action of determining a second link failure, the first transceiver triggers the second link recovery procedure; when the fifth condition is unsatisfied, the first transceiver drops triggering a second link recovery procedure; where the fifth condition comprises that the second link recovery procedure comprises a random access procedure.

7. A second node for wireless communications, comprising:
a second transmitter, transmitting a first signal set and a second signal set; and
a second transceiver, monitoring whether a first link recovery procedure is started;
wherein when a measurement of the first signal set is used to determine a first link failure, the first link recovery procedure is started; when a measurement of the second signal set is used to determine a second link failure, at least one of a first parameter or a second parameter is used to determine whether a second link recovery procedure is triggered; each of the first signal set and the second signal set respectively comprises at least one reference signal associated with a first cell, and there exists at least one reference signal that only belongs to one of the first signal set or the second signal set; the first parameter is a time of the first link recovery procedure relative to the action of determining a second link failure, and the second parameter is whether the second link recovery procedure comprises a random access procedure.

8. The second node according to claim 7, wherein when a first condition is satisfied, triggering of the second link recovery procedure is dropped; where the first condition comprises that the first link recovery procedure is started before the action of determining a second link failure; or, the first condition comprises that the first link recovery procedure is started before the action of determining a second link failure, and that the first link recovery procedure is not successfully completed before the action of determining a second link failure;
or, when a second condition is satisfied, as a response to the action of determining a second link failure, the second link recovery procedure is triggered; where the second condition comprises that the first link recovery procedure is successfully completed before the action of determining a second link failure.

9. The second node according to claim 7, wherein when a third condition is satisfied, the second link recovery procedure is triggered; where the third condition comprises that the first link recovery procedure is started after the action of determining a second link failure;
or, when a third condition is satisfied, the second link recovery procedure is triggered; where the third condition comprises that the first link recovery procedure is started after the action of determining a second link failure; when the third condition and a fourth condition are both satisfied, as a response to the first link recovery procedure being triggered, the second link recovery procedure is terminated; where the fourth condition comprises that the second link recovery procedure is started and not successfully completed before the action of determining a first link failure.

10. The second node according to claim 7, wherein when a fifth condition is satisfied, as a response to the action of determining a second link failure, the second link recovery procedure is triggered; when the fifth condition is unsatisfied, triggering of the second link recovery procedure is dropped; where the fifth condition comprises that the second link recovery procedure comprises a random access procedure.

11. A method in a first node for wireless communications, comprising:
receiving a first signal set and a second signal set; a measurement of the first signal set being used to determine a first link failure; and a measurement of the second signal set being used to determine a second link failure; and
as a response to the action of determining a first link failure, starting a first link recovery procedure; and determining according to at least one of a first parameter or a second parameter whether to trigger a second link recovery procedure as a response to the action of determining a second link failure;
wherein each of the first signal set and the second signal set respectively comprises at least one reference signal associated with a first cell, and there exists at least one reference signal that only belongs to one of the first signal set or the second signal set; the first parameter is a time of the first link recovery procedure relative to the action of determining a second link failure, and the second parameter is whether the second link recovery procedure comprises a random access procedure.

12. The method according to claim 11, wherein the phrase of a measurement of the first signal set being used to determine a first link failure comprises: as a response to a received quality of each reference signal in the first signal set being lower than a first threshold, reporting to higher layers a first-type indication used for updating a first counter; the phrase of a measurement of the second signal set being used to determine a second link failure comprises: as a response to a received quality of each reference signal in the second signal set being lower than a second threshold, reporting to higher layers a second-type indication used for updating a second counter.

13. The method according to claim 11, comprising: when a first condition is satisfied, dropping triggering the second link recovery procedure; where the first condition comprises that the first link recovery procedure is started before the action of determining a second link failure; or, the first condition comprises that the first link recovery procedure is started before the action of determining a second link failure, and that the first link recovery procedure is not successfully completed before the action of determining a second link failure.

14. The method according to claim 11, comprising: when a second condition is satisfied, as a response to the action of determining a second link failure, triggering the second link recovery procedure; where the second condition comprises that the first link recovery procedure is successfully completed before the action of determining a second link failure.

15. The method according to claim 11, comprising: when a third condition is satisfied, starting the second link recovery procedure; where the third condition comprises that the first link recovery procedure is started after the action of determining a second link failure;
or, comprising: when the third condition is satisfied, starting the second link recovery procedure; where the third condition comprises that the first link recovery procedure is started after the action of determining a second link failure; when the third condition and a fourth condition are both satisfied, as a response to triggering a first link recovery procedure, the first transceiver terminates the second link recovery procedure; where the fourth condition comprises that the second link recovery procedure is started and not successfully completed before the action of determining a first link failure.

16. The method according to claim 11, comprising: when a fifth condition is satisfied, as a response to the action of determining a second link failure, triggering the second link recovery procedure; when the fifth condition is unsatisfied, dropping triggering a second link recovery procedure; where the fifth condition comprises that the second link recovery procedure comprises a random access procedure.

17. A method in a second node for wireless communications, comprising:
transmitting a first signal set and a second signal set; and
monitoring whether a first link recovery procedure is started;
wherein when a measurement of the first signal set is used to determine a first link failure, the first link recovery procedure is started; when a measurement of the second signal set is used to determine a second link failure, at least one of a first parameter or a second parameter is used to determine whether a second link recovery procedure is triggered; each of the first signal set and the second signal set respectively comprises at least one reference signal associated with a first cell, and there exists at least one reference signal that only belongs to one of the first signal set or the second signal set; the first parameter is a time of the first link recovery procedure relative to the action of determining a second link failure, and the second parameter is whether the second link recovery procedure comprises a random access procedure.

18. The method according to claim 17, wherein when a first condition is satisfied, triggering of the second link recovery procedure is dropped; where the first condition comprises that the first link recovery procedure is started before the action of determining a second link failure; or, the first condition comprises that the first link recovery procedure is started before the action of determining a second link failure, and that the first link recovery procedure is not successfully completed before the action of determining a second link failure;
or, when a second condition is satisfied, as a response to the action of determining a second link failure, the second link recovery procedure is triggered; where the second condition comprises that the first link recovery procedure is successfully completed before the action of determining a second link failure.

19. The method according to claim 17, wherein when a third condition is satisfied, the second link recovery procedure is triggered; where the third condition comprises that the first link recovery procedure is started after the action of determining a second link failure;
or, when a third condition is satisfied, the second link recovery procedure is triggered; where the third condition comprises that the first link recovery procedure is started after the action of determining a second link failure; when the third condition and a fourth condition are both satisfied, as a response to the first link recovery procedure being triggered, the second link recovery procedure is terminated; where the fourth condition comprises that the second link recovery procedure is started and not successfully completed before the action of determining a first link failure.

20. The method according to claim 17, wherein when a fifth condition is satisfied, as a response to the action of determining a second link failure, the second link recovery procedure is triggered; when the fifth condition is unsatisfied, triggering of the second link recovery procedure is dropped; where the fifth condition comprises that the second link recovery procedure comprises a random access procedure.
